(19) United States
(12) Patent Application Publication
(10) Pub. No.: US 2013/0132692 A1
(43) Pub. Date: May 23, 2013

(54) STORAGE DEVICES AND STORAGE SYSTEMS

(71) Applicants: Jun KATO, Kawasaki (JP); Toshihiro OZAWA, Yokohama (JP); Yasuo NOGUCHI, Kawasaki (JP); Kazutaka OGIHARA, Hachioji (JP); Kazuichi OE, Yokohama (JP); Munenori MAEDA, Yokohama (JP); Masahisa TAMURA, Kawasaki (JP); Tatsuo KUMANO, Kawasaki (JP); Ken Iizawa, Yokohama (JP)

(72) Inventors: Jun KATO, Kawasaki (JP); Toshihiro OZAWA, Yokohama (JP); Yasuo NOGUCHI, Kawasaki (JP); Kazutaka OGIHARA, Hachioji (JP); Kazuichi OE, Yokohama (JP); Munenori MAEDA, Yokohama (JP); Masahisa TAMURA, Kawasaki (JP); Tatsuo KUMANO, Kawasaki (JP); Ken Iizawa, Yokohama (JP)

(73) Assignee: FUJITSU LIMITED, Kawasaki-shi (JP)

(21) Appl. No.: 13/615,863

(22) Filed: Sep. 14, 2012

(30) Foreign Application Priority Data
Nov. 21, 2011 (JP) 2011-254469

(51) Int. Cl. G06F 12/16

(52) U.S. Cl. 711/162; 711/E12.103

(57) ABSTRACT

A storage device is one of a plurality of storage devices storing replicas of data. The storage device includes a memory and a processor coupled to the memory. The processor executes a process includes transmitting an update request to at least one destination storage device through a plurality of paths when the storage device is requested to update the data by a client. The process includes notifying the client that the updating of the data has been completed when having received a response through one of the paths, the response being issued by the destination storage device serving as the terminal point of the path when the destination storage device receives the update request through all the paths having the destination storage device as the terminal point.

### CROSS-REFERENCE TO RELATED APPLICATION

This application is based upon and claims the benefit of priority of the prior Japanese Patent Application No. 2011-254469, filed on Nov. 21, 2011, the entire contents of which are incorporated herein by reference.

### FIELD

The embodiments discussed herein are directed to storage devices and storage systems.

### BACKGROUND

In storage systems including NoSQL, such as distributed Key-Value Store (KVS), there has been a known technique of storing replicas of data into more than one node. In storage systems having such a technique applied thereto, replicas are stored in more than one node, so as to prevent data loss due to a disk failure or the like. Also, reading data from the replicas stored in the respective nodes is allowed, so as to disperse access load.

There are cases where the storage system keeps strong consistency to guarantee consistency in the data read from the respective replicas. As an example technique to maintain such strong consistency, a chain replication technique has been known. An example of a storage system having such chain replication applied thereto is described below.

FIG. 23 is a diagram for explaining an example of chain replication. In the example illustrated in FIG. 23, CRAQ (Chain Replication with Apportioned Query) is applied as an example of chain replication to a storage system.

In the example illustrated in FIG. 23, the storage system includes N nodes storing the same replicas. Of the N nodes in the storage system, the nodes other than a 1st node, a 2nd node, a 3rd node, and an Nth node are not illustrated in the example illustrated in FIG. 23.

When requested to update the replicas by a client, each of the nodes included in such a storage system sequentially transfers an “update” request for updating of the replicas. In the example indicated by (a) in FIG. 23, the client issues a replica update request to the 1st node. In such a case, the 1st node prepares for the updating of the replicas, and transmits the “update” request to the 2nd node, as indicated by (b) in FIG. 23.

Upon receipt of the “update” request from the 1st node, the 2nd node prepares for the updating of the replicas, and transfers the “update” request to the 3rd node. After that, each of the nodes sequentially transfers the “update” request toward the Nth node serving as the terminal point of the path. Also, as indicated by (c) in FIG. 23, upon receipt of the “update” request, the Nth node serving as the terminal point of the path updates the replicas, and transmits an “updated” request as a response to the “update” request, to the previous node in the path.

Thereafter, upon receipt of the “updated” request, each of the nodes updates the replicas and transfers the “updated” request along the one-dimensional path toward the 1st node serving as the start node. Upon receipt of the “updated” request, the 1st node updates the replicas, and notifies the client that the updating has been completed, as indicated by (d) in FIG. 23.
Non Patent Literature 1: Jeff Terrace and Michael J. Freedman, Princeton University, “Object Storage on CRAQ, High-throughput chain replication for read-mostly workloads,” USENIX Annual Technical Conference in San Diego, Calif., June 2009
Non Patent Literature 2: Robbert van Renesse and Fred B. Schneider, “Chain Replication for Supporting High Throughput and Availability,” USENIX Association OSDI' 04, the 6th Symposium on Operation Systems Design and Implementation

According to the above described chain replication technique, however, the “update” request is sequentially transferred through a single path sequentially connecting the respective nodes, to update the replicas. Therefore, as the number of nodes increases, the time for updating becomes longer.

For example, according to the above described chain replication technique, the time for updating data is doubled when the number of nodes is doubled. In a storage system using a distributed environment technique to disperse the node installation locations, the nodes are installed across a wide area, and the distance between each two nodes becomes longer. As a result, delays in the network increase, and the time for updating replicas becomes a bottleneck.

### SUMMARY

According to an aspect of an embodiment, a storage device is one of a plurality of storage devices storing replicas of data. The storage device includes a memory and a processor coupled to the memory. The processor executes a process includes transmitting an update request for updating of the data to at least one destination storage device through a plurality of paths when the storage device is requested to update the data by a client, the each of paths having the storage device requested to update data by the client as a start point and the destination storage device as a terminal point. The process includes notifying the client that the updating of the data has been completed when having received a response through one of the paths, the response being issued by the destination storage device serving as the terminal point of the path when the destination storage device receives the update request through all the paths having the destination storage device as the terminal point.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an example of a storage system according to a first embodiment;

FIG. 2A is a table for explaining nodes that store replicas of data A;

FIG. 2B is a table for explaining nodes that store replicas of data B;

FIG. 2C is a table for explaining nodes that store replicas of data C;

FIG. 3 is a diagram for explaining an example of a start node according to the first embodiment;

FIG. 4A is a table for explaining an example of location information stored in a data storing unit according to the first embodiment;

FIG. 4B is a table for explaining an example of the information indicating the nodes that store respective replicas A1 to A4 stored in the data storing unit according to the first embodiment;

FIG. 5 is a diagram for explaining an example operation to be performed by a start node according to the first embodiment to issue “update” requests;

FIG. 6 is a diagram for explaining an example operation to be performed by a start node according to the first embodiment upon receipt of an “updated” request;

FIG. 7 is a diagram for explaining an example of a terminal node according to the first embodiment;

FIG. 8 is a diagram for explaining an example operation to be performed by a terminal node according to the first embodiment;

FIG. 9A is a diagram for explaining an operation to be performed by the storage system according to the first embodiment to transmit “update” requests through more than one path;

FIG. 9B is a diagram for explaining an operation to be performed by the storage system according to the first embodiment to transmit “updated” requests through more than one path;

FIG. 10 is a flowchart for explaining an example of the flow of processing to be performed by a start node;

FIG. 11 is a flowchart for explaining an example of the flow of processing to be performed by an intermediate node;

FIG. 12 is a flowchart for explaining an example of the flow of processing to be performed by a terminal node;

FIG. 13 is a diagram for explaining an example of a storage system according to a second embodiment;

FIG. 14 is a diagram for explaining an example of a start node according to the second embodiment;

FIG. 15 is a diagram for explaining an example of a terminal node according to the second embodiment;

FIG. 16 is a diagram for explaining an example operation to be performed by a terminal node according to the second embodiment upon receipt of a “Get” request;

FIG. 17 is a diagram for explaining an example operation to be performed by a terminal node according to the second embodiment upon receipt of an “update” request;

FIG. 18A is a diagram for explaining an operation to be performed by the storage system according to the second embodiment to transmit “update” requests through more than one path;

FIG. 18B is a diagram for explaining an operation to be performed by a terminal node according to the second embodiment to transmit and receive “readyToUpdate” requests;

FIG. 18C is a diagram for explaining an operation to be performed by the storage system according to the second embodiment to transmit “updated” requests;

FIG. 18D is a diagram for explaining an operation to be performed in the storage system according to the second embodiment;

FIG. 19 is a diagram for explaining an operation to be performed by the terminal node of more than one path;

FIG. 20 is a flowchart for explaining the flow of processing to be performed by a terminal node according to the second embodiment;

FIG. 21 is a flowchart for explaining an example of the flow of processing to be performed in response to a “Get” request;

FIG. 22 is a diagram for explaining an example of a computer that executes a data update program; and

FIG. 23 is a diagram for explaining an example of chain replication.

### DESCRIPTION OF EMBODIMENTS

Preferred embodiments of the present invention will be explained with reference to accompanying drawings.

### [a] First Embodiment

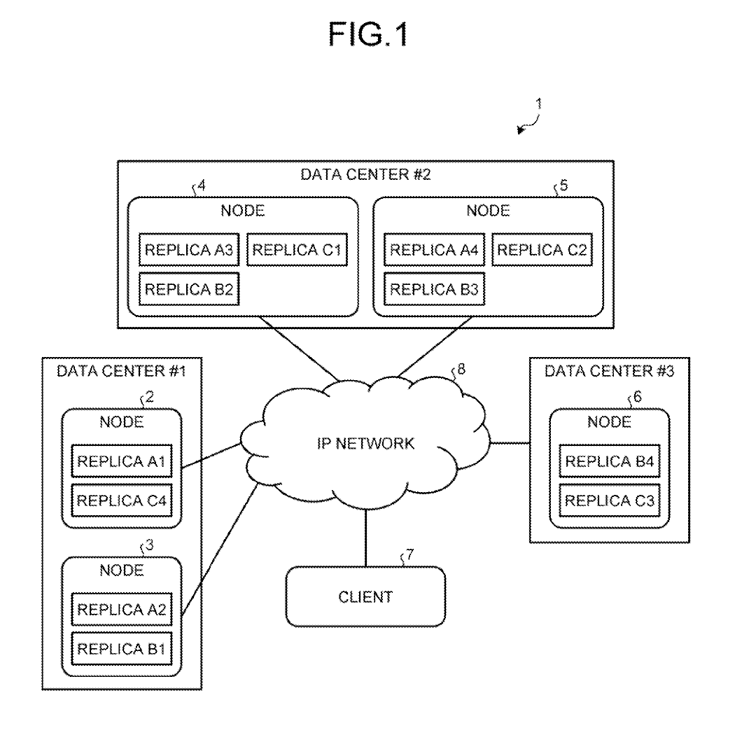

In a first embodiment described below, an example of a storage system is described, with reference to FIG. 1. FIG. 1 is a diagram for explaining the example of a storage system according to the first embodiment. In the following description, each node is a storage device or a server or the like that includes an information processing device storing replicas that are data replicas, and an arithmetic processing unit that performs communications with other nodes, data updating operations, data managing operations, and the like.

As illustrated in FIG. 1, a storage system 1 is a system that connects data centers #1 to #3 and a client 7 via an IP (Internet Protocol) network 8. A node 2 and a node 3 are installed in the data center #1, a node 4 and a node 5 are installed in the data center #2, and a node 6 is installed in the data center #3.

Each of the nodes 2 to 6 stores replicas that are data replicas. Specifically, the respective nodes 2 to 6 store, in a dispersive manner, replicas A1 to A4, which are replicas of data A, replicas B1 to B4, which are replicas of data B, and replicas C1 to C4, which are replicas of data C.

In the example illustrated in FIG. 1, the node 2 stores the replica A1 and the replica C4. The node 3 stores the replica A2 and the replica B1. The node 4 stores the replica A3, the replica C1, and the replica B2. The node 5 stores the replica A4, the replica C2, and the replica B3. The node 6 stores the replica B4 and the replica C3.

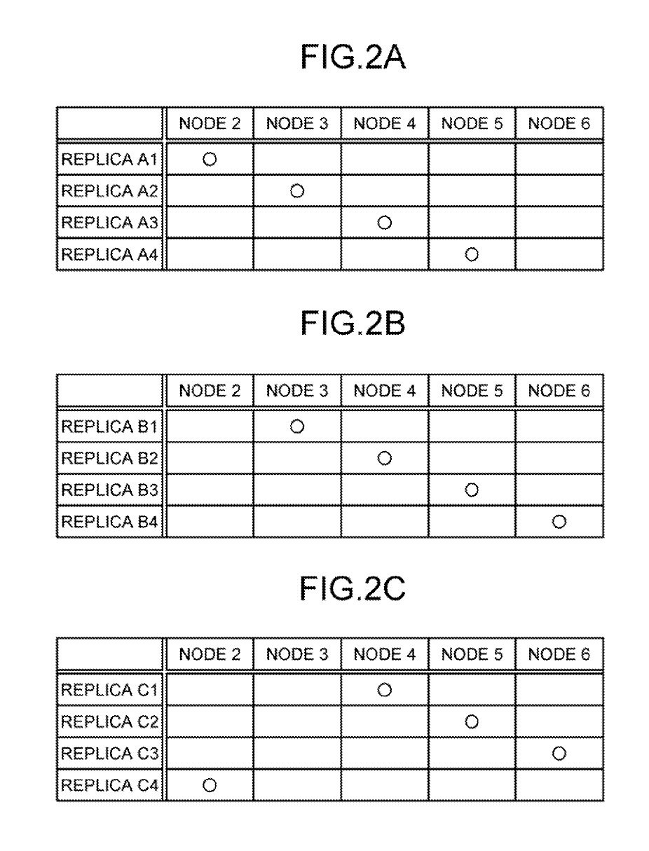

Referring now to FIGS. 2A to 2C, which ones of the replicas of the data A to C are stored in which ones of the nodes 2 to 6 is described. FIG. 2A is a table for explaining the nodes that store the replicas of the data A. FIG. 2B is a table for explaining the nodes that store the replicas of the data B. FIG. 2C is a table for explaining the nodes that store the replicas of the data C. In FIGS. 2A to 2C, the respective replicas are allotted to the respective rows, and the respective nodes 2 to 6 are allotted to the respective columns. Each replica allotted to a row is stored in the node allotted to the column having a circle marked in the row.

For example, as illustrated in FIG. 2A, the replicas A1 to A4, which are replicas of the data A, are stored in the nodes 2 to 5. As illustrated in FIG. 2B, the replicas B1 to B4, which are replicas of the data B, are stored in the nodes 3 to 6. As illustrated in FIG. 2C, the replicas C1 to C4, which are replicas of the data C, are stored in the node 2 and the nodes 4 to 6.

The client 7 reads the respective pieces of data A to C and updates the respective pieces of data A to C, using the respective replicas A1 to A4, B1 to B4, and C1 to C4 stored in the respective nodes 2 to 6. Specifically, the client 7 stores information indicating which ones of the replicas A1 to A4, B1 to B4, and C1 to C4 are stored in which ones of the nodes.

The client 7 issues a “Get” request indicating a replica readout request to the terminal node of a path for transferring an “update” request, via the IP network 8. For example, where the node 5 serves as the terminal node in updating the data A, the client 7 issues the “Get” request to the node 5.

The client 7 also issues a “Put” request indicating a replica update request to a node predetermined for each replica, via the IP network 8. That is, the client 7 issues the “Put” request to the start nodes of the paths for transferring the “update” request in updating the respective replicas A1 to A4, B1 to B4, and C1 to C4. For example, to update the replicas A1 to A4, the client 7 issues the “Put” request to the node 2 storing the replica A1.

To update the replicas B1 to B4, the client 7 issues the “Put” request to the node 3 storing the replica B1. To update the replicas C1 to C4, the client 7 issues the “Put” request to the node 4 storing the replica C1.

When having obtained the “Get” request from the client 7, each of the nodes 2 to 6 being the terminal node of the path transmits the data of the replica designated by the “Get” request to the client 7. When having obtained the “Put” request, each of the nodes 2 to 4 being the start node of the path has own storage device as a start point and transmits the “update” request for updating the replicas to the node serving as the terminal of each of paths that connect the nodes storing the replicas to be updated in series. Here, each “update” request is transmitted along the paths.

For example, when having obtained the “Put” request concerning the replica A from the client 7, the node 2 performs the following operation. That is, the node 2 identifies the nodes 3 to 5 storing the replicas A to be updated. The node 2 then identifies the paths for transmitting “update” requests. For example, the node 2 identifies the path extending from the node 2 to the node 3 to the node 5, and the path extending from the node 2 to the node 4 to the node 5, as the paths for transmitting “update” requests.

The node 2 transfers an “update” request having a header in which the path information indicating the path for transmitting the “update” request is embedded, to each of the nodes 3 and the node 4. In this case, the node 3 prepares for the updating of the replica A2, and identifies the node 5 as the transfer destination of the “update” request by referring to the path information embedded in the header of the “update” request. The node 3 then transfers the “update” request to the node 5.

Upon receipt of the “update” request, the node 4 prepares for the updating of the replica A3, and identifies the node 5 as the transfer destination of the “update” request by referring to the path information embedded in the header of the “update” request. The node 4 then transfers the “update” request to the node 5.

When having obtained the “update” requests from the node 3 or the node 4, the node 5 refers to the path information, and determines itself to be the terminal node of more than one path. In such a case, the node 5 stands by until receiving “update” requests through all the paths through which the “update” requests are transferred.

After receiving the “update” requests through all the paths, or after receiving the “update” requests via the node 3 and the node 4, the node 5 updates the replica A4, and transmits an “updated” request, which is a response to each “update” request, to the node 3 and the node 4.

Upon receipt of the “updated” request from the node 5, the node 3 and the node 4 update the replica A2 and the replica A3, and transfer the “updated” request to the node 2. Obtaining the “updated” request from the node 3 or the node 4, the node 2 updates the replica A1, and transmits an update completion notification to the client 7.

By performing the above operation, the nodes 2 to 5 can maintain strong consistency to guarantee consistency in readout data. Also, the nodes 2 to 5 distribute “update” requests to all the nodes storing the replicas of the data A through more than one path. Accordingly, the time for updating the replicas can be shortened.

The nodes 2 to 6 perform the same operation as above for the replicas B1 to B4 and the replicas C1 to C4. Accordingly, the storage system 1 can shorten the time for updating each replica.

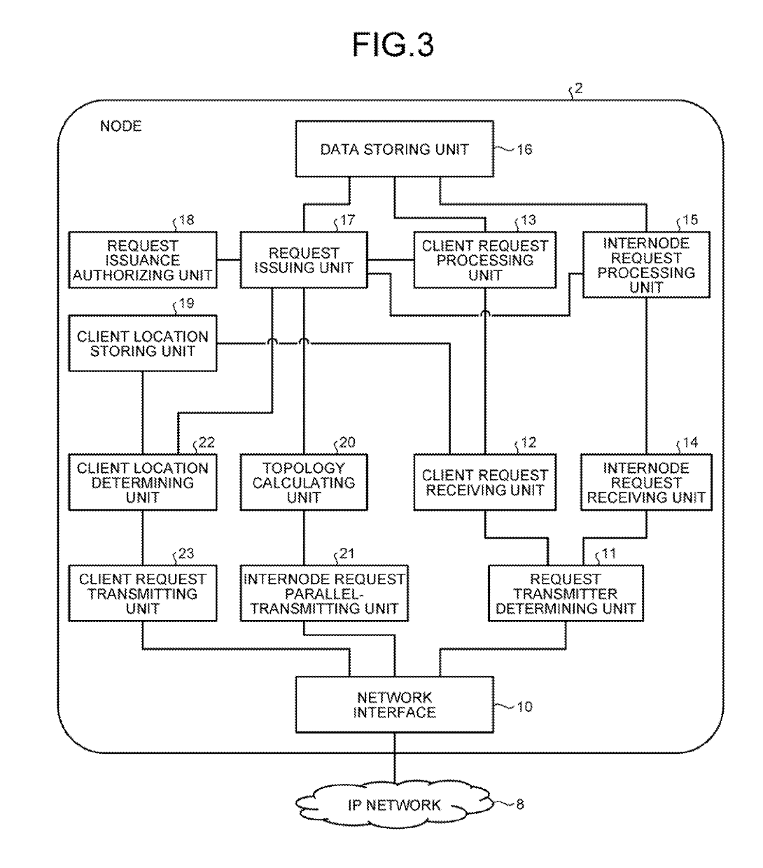

Next, the respective nodes 2 to 6 are described. Referring first to FIG. 3, an example case where the node 2 operates as a start node that is the start point of more than one path, and as an intermediate node that transfers an “update” request in a path, is described. In addition each of the other nodes 3 to 6 also includes the respective components illustrated in FIGS. 2A to 2C. That is, each of the nodes 2 to 6 can operate as the start node that receives a “Put” request from the client 7, depending on the stored replicas and the settings in the storage system 1.

FIG. 3 is a diagram for explaining an example of a start node according to the first embodiment. In the example illustrated in FIG. 3, the node 2 operating as a start node includes a network interface 10, a request transmitter determining unit 11, a client request receiving unit 12, a client request processing unit 13, an internode request receiving unit 14, and an internode request processing unit 15. The node 2 also includes a data storing unit 16, a request issuing unit 17, a request issuance authorizing unit 18, a client location storing unit 19, a topology calculating unit 20, an internode request parallel-transmitting unit 21, a client location determining unit 22, and a client request transmitting unit 23.

In the following, the respective components 10 to 23 included in the node 2 are described. First, the data storing unit 16 included in the node 2 is described. The data storing unit 16 is a storing unit that stores data of replicas, the installation locations of the other nodes, and the like. In a case where the node 2 serves as a start node when updating the replicas A1 to A4 of the data A, for example, the data storing unit 16 stores information indicating the nodes storing the respective replicas A1 to A4. The data storing unit 16 also stores location information indicating the locations at which the respective nodes 2 to 6 are installed.

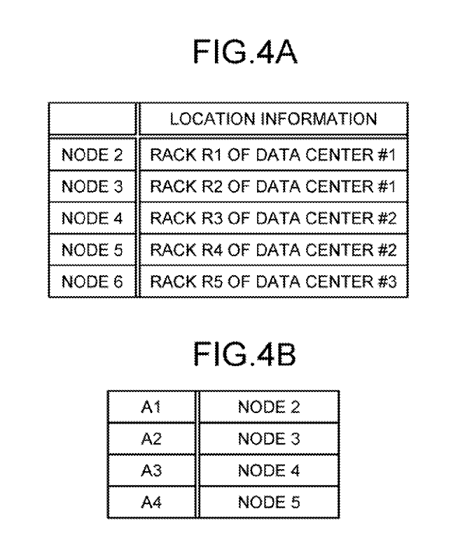

FIG. 4A is a table for explaining an example of the location information stored in the data storing unit according to the first embodiment. In the example illustrated in FIG. 4A, the data storing unit 16 stores location information indicating that the node 2 is installed in a rack R1 of the data center #1, and location information indicating that the node 3 is installed in a rack R2 of the data center #1.

The data storing unit 16 also stores location information indicating that the node 4 is installed in a rack R3 of the data center #2, and location information indicating that the node 5 is installed in a rack R4 of the data center #2. The data storing unit 16 also stores location information indicating that the node 6 is installed in a rack R5 of the data center #3.

FIG. 4B is a table for explaining an example of the information that is stored in the data storing unit according to the first embodiment and indicates the nodes storing the respective replicas A1 to A4. In the example illustrated in FIG. 4B, the data storing unit 16 stores information indicating that the replica A1 is stored in the node 2, the replica A2 is stored in the node 3, the replica A3 is stored in the node 4, and the replica A4 is stored in the node 5.

As described below, when operating as a start node, the node 2 identifies the nodes to which “update” requests are to be distributed, and the paths for transferring the “update” requests, by using the respective pieces of information stored in the data storing unit 16. The node 2 transmits the “update” requests to the nodes adjacent to the node 2 in the identified paths.

Referring back to FIG. 3, the client location storing unit 19 is a storing unit that stores information indicating the client that has issued a “Put” request or “Get” request to the node 2. For example, the client location storing unit 19 stores the IP address or the like of the client 7, which has issued the “Put” request to the node 2.

The network interface 10 receives the “Put” request issued by the client 7, and an “update” request and an “updated” request transmitted from the other nodes 3 to 6, via the IP network 8. In such cases, the network interface 10 outputs the received “Put” request, the received “update” request, and the received “updated” request to the request transmitter determining unit 11.

When having obtained the “update” request and the “updated” request from the internode request parallel-transmitting unit 21, the network interface 10 transmits the obtained “update” request and the obtained “updated” request to the other nodes 3 to 6. When having obtained replica data or a notification to the effect that an updating operation has been finished from the client request transmitting unit 23, the network interface 10 transmits the obtained data or notification to the client 7.

When having obtained each request obtained by the network interface 10, the request transmitter determining unit 11 determines whether the obtained request is a “Put” request. If the obtained request is a “Put” request, the request transmitter determining unit 11 outputs the obtained “Put” request to the client request receiving unit 12. If the obtained request is not a “Put” request, or if the obtained request is an “update” request or an “updated” request, the request transmitter determining unit 11 outputs the obtained request to the internode request receiving unit 14.

When having obtained a “Put” request from the request transmitter determining unit 11, the client request receiving unit 12 identifies the client 7, which has issued the obtained “Put” request. The client request receiving unit 12 stores the location information about the identified client 7 into the client location storing unit 19. The client request receiving unit 12 also outputs the obtained “Put” request to the client request processing unit 13. Here, an example of the location information about the client 7 is the IP address of the client 7 or the like, which is a number uniquely identifying the client 7.

The client request processing unit 13 performs an operation in accordance with the “Put” request obtained from the client request receiving unit 12. For example, when having obtained the “Put” request from the client request receiving unit 12, the client request processing unit 13 retrieves the data of the replica designated in the “Put” request, from the data storing unit 16.

The client request processing unit 13 then newly generates updated data by updating the detected replica data in accordance with the “Put” request, and stores the updated data into the data storing unit 16 separately from the pre-updated data. The client request processing unit 13 also instructs the request issuing unit 17 to issue an “update” request.

When having obtained an “update” request from the request transmitter determining unit 11, the internode request receiving unit 14 outputs the “update” request to the internode request processing unit 15. When having obtained an “updated” request from the request transmitter determining unit 11, the internode request receiving unit 14 outputs the “updated” request to the internode request processing unit 15.

When having obtained an “update” request from the internode request receiving unit 14, the internode request processing unit 15 performs the following operation. First, the internode request processing unit 15 retrieves the replica to be updated from the data storing unit 16, and generates updated data by updating the retrieved replica data. The internode request processing unit 15 then stores the updated data, as well as the pre-updated data, into the data storing unit 16. The internode request processing unit 15 also outputs the “update” request output from the internode request receiving unit 14 to the request issuing unit 17, and instructs the request issuing unit 17 to perform an operation to transfer the “update” request.

When having obtained an “updated” request from the internode request receiving unit 14, the internode request processing unit 15 performs the following operation. First, the internode request processing unit 15 deletes the replica retrieved prior to the update by the client request processing unit 13, from the data storing unit 16. The internode request processing unit 15 then determines whether the “updated” request received by the internode request receiving unit 14 is the “updated” request issued as a response to an “update” request issued by the node 2.

If the “updated” request obtained by the internode request receiving unit 14 is determined to be the “updated” request issued as a response to an “update” request issued by the node 2 serving as a start node, the internode request processing unit 15 performs the following operation. That is, the internode request processing unit 15 instructs the request issuing unit 17 to issue a “Put” response notifying that the “Put” request has been satisfied. Where the node 2 is a start node, the node 2 receives more than one “updated” request through more than one path. However, when the node 2 receives a first “updated” request, the internode request processing unit 15 deletes the pre-updated version of the replica data.

If the “updated” request obtained by the internode request receiving unit 14 is determined not to be an “updated” request issued as a response to an “update” request issued by the node 2 serving as a start node, the internode request processing unit 15 performs the following operation. That is, the internode request processing unit 15 deletes the replica data retrieved prior to the update by the internode request processing unit 15, from the data storing unit 16. The internode request processing unit 15 then outputs the “updated” request output from the internode request receiving unit 14 to the request issuing unit 17, and instructs the request issuing unit 17 to transfer the “updated” request.

When having been instructed to issue an “update” request by the client request processing unit 13, the request issuing unit 17 performs the following operation. That is, the request issuing unit 17 refers to the data storing unit 16, to identify the node to which the “update” request is to be transmitted, or the node storing the replica to be updated. The request issuing unit 17 also obtains the location information about the identified node from the data storing unit 16. The request issuing unit 17 then generates the “update” request, and instructs the topology calculating unit 20 to transmit the generated “update” request. At this point, the request issuing unit 17 transmits the obtained node location information to the topology calculating unit 20.

When having been instructed to perform an operation to transfer an “update” request by the internode request processing unit 15, the request issuing unit 17 performs the following operation. That is, the request issuing unit 17 outputs the “update” request output from the internode request processing unit 15 to the topology calculating unit 20, and instructs the topology calculating unit 20 to transfer the “update” request.

When having been instructed to perform an operation to transfer an “updated” request by the internode request processing unit 15, the request issuing unit 17 performs the following operation. That is, the request issuing unit 17 outputs the “updated” request output from the internode request processing unit 15 to the topology calculating unit 20, and instructs the topology calculating unit 20 to transfer the “updated” request.

When having been instructed to issue a “Put” response by the internode request processing unit 15, the request issuing unit 17 performs the following operation. That is, the request issuing unit 17 instructs the request issuance authorizing unit 18 to determine whether to issue a “Put” response.

When having received a notification to issue a “Put” response from the request issuance authorizing unit 18, the request issuing unit 17 generates a “Put” response, and instructs the client location determining unit 22 to issue the generated “Put” response. When having received a notification not to issue a “Put” response from the request issuance authorizing unit 18, on the other hand, the request issuing unit 17 ends the operation.

When having been instructed to determine whether to issue a “Put” response by the request issuing unit 17, the request issuance authorizing unit 18 performs the following operation. That is, the request issuance authorizing unit 18 determines whether there is a record indicating that the request issuing unit 17 has issued the same “Put” response.

If there is not a record indicating that the same “Put” response has been issued, the request issuance authorizing unit 18 notifies the request issuing unit 17 that the “Put” response is to be issued, and stores a record indicating that the “Put” response has been issued. If there is a record indicating that the same “Put” response has been issued, the request issuance authorizing unit 18 notifies the request issuing unit 17 that the “Put” response is not to be issued.

When having been instructed to transmit an “update” request, the topology calculating unit 20 performs the following operation. First, the topology calculating unit 20 obtains node location information from the request issuing unit 17. Using the obtained node location information, the topology calculating unit 20 identifies the paths for transferring the “update” request.

At this point, the topology calculating unit 20 identifies the paths in which each two nodes in installation locations close to each other are in the same path. The topology calculating unit 20 also identifies the paths having the same node as the terminal node of each of the paths. The topology calculating unit 20 stores path information indicating the identified paths into the header of the “update” request. The topology calculating unit 20 then outputs the “update” request storing the path information to the internode request parallel-transmitting unit 21, and instructs the internode request parallel-transmitting unit 21 to transmit the “update” request.

When the node 2 has received a “Put” request concerning the replicas A1 to A4 of the data A from the client 7, for example, the topology calculating unit 20 obtains an “update” request from the request issuing unit 17, and obtains the location information about the respective nodes 2 to 5 in the example illustrated in FIG. 4A. In such a case, the node 2 determines that the node 2 and the node 3 are installed in the data center #1, and the node 4 and the node 5 are installed in the data center #2.

Where the respective nodes 2 to 5 are installed in the above manner, the latency increases at the time of transmission of an “update” request along a path that crosses a data center. Therefore, the topology calculating unit 20 identifies paths that do not cross any data center, wherever possible. The topology calculating unit 20 also sets the same node as the terminal node of each of the paths, so as to facilitate maintenance of strong consistency.

Where two or more terminal nodes exist in the paths for transmitting an “update” request, the algorithm for selecting a terminal node as the inquiry destination becomes complicated when a “Get” request is obtained between the time when an “update” request is obtained and the time when an “updated” request is obtained. Therefore, the topology calculating unit 20 sets the same node as the terminal node of each of the paths.

For example, in a case where the respective nodes 2 to 6 are installed as illustrated in FIG. 4A, and the nodes 2 to 5 store the replicas A1 to A4, the topology calculating unit 20 identifies the paths described below when the client 7 issues a “Put” request concerning the data A. That is, the topology calculating unit 20 identifies a path that has the node 2 as the start node and has the node 5 as the terminal node via the node 3, and also identifies a path that has the node 2 as the start node and has the node 5 as the terminal node via the node 4.

When having obtained an “update” request from the request issuing unit 17 and having been instructed to transfer the “update” request, the topology calculating unit 20 performs the following operation. That is, the topology calculating unit 20 outputs the “update” request to the internode request parallel-transmitting unit 21, and instructs the internode request parallel-transmitting unit 21 to transfer the “update” request.

When having obtained an “updated” request from the request issuing unit 17 and having been instructed to transfer the “updated” request, the topology calculating unit 20 performs the following operation. That is, the topology calculating unit 20 outputs the “updated” request to the internode request parallel-transmitting unit 21, and instructs the internode request parallel-transmitting unit 21 to transfer the “updated” request.

When having obtained an “update” request from the topology calculating unit 20 and having been instructed to transmit the “updated” request, the internode request parallel-transmitting unit 21 performs the following operation. That is, in the paths indicated by the path information stored in the “update” request, the internode request parallel-transmitting unit 21 identifies the nodes to which the “update” request is to be transmitted after the node 2 as the start node. The internode request parallel-transmitting unit 21 then transmits the “update” request to the identified nodes via the network interface 10 and the IP network 8.

For example, the internode request parallel-transmitting unit 21 analyzes the path information, and identifies a path that has the node 2 as the start node and has the node 5 as the terminal node via the node 3. The internode request parallel-transmitting unit 21 also identifies a path that has the node 2 as the start node and has the node 5 as the terminal node via the node 4. In such a case, the internode request parallel-transmitting unit 21 transmits the “update” request to the node 3 and the node 4.

When having obtained an “update” request and having been instructed to transfer the “update” request, the internode request parallel-transmitting unit 21 performs the following operation. First, the internode request parallel-transmitting unit 21 analyzes the path information stored in the “update” request, and identifies the node to which the “update” request is to be transferred after the node 2. The internode request parallel-transmitting unit 21 then transfers the “updated” request to the identified node via the network interface 10.

When having obtained an “updated” request and having been instructed to transfer the “updated” request, the internode request parallel-transmitting unit 21 performs the following operation. First, the internode request parallel-transmitting unit 21 analyzes the path information stored in the “update” request, and identifies the node to which the “updated” request is to be transferred after the node 2. The internode request parallel-transmitting unit 21 then transfers the “updated” request to the identified node via the network interface 10.

When having obtained replica data from the request issuing unit 17 and having been instructed to transmit the replica data to the client 7, the client location determining unit 22 performs the following operation. That is, the client location determining unit 22 obtains the location information about the client 7, such as the IP address of the client 7, from the client location storing unit 19. The client location determining unit 22 then outputs the replica data and the location information about the client 7 to the client request transmitting unit 23.

When having been instructed to issue a “Put” response by the request issuing unit 17, the client location determining unit 22 performs the following operation. That is, the client location determining unit 22 obtains, from the client location storing unit 19, the location information about the client as the issuance destination of the “Put” response. The client location determining unit 22 then outputs the location information about the client and the “Put” response to the client request transmitting unit 23.

When having obtained a “Put” response and the location information about a client from the client location determining unit 22, the client request transmitting unit 23 transmits the “Put” response to the client via the network interface 10 and the IP network 8. For example, when having obtained the location information about the client 7 and a “Put” response, the client request transmitting unit 23 transmits the “Put” response to the client 7.

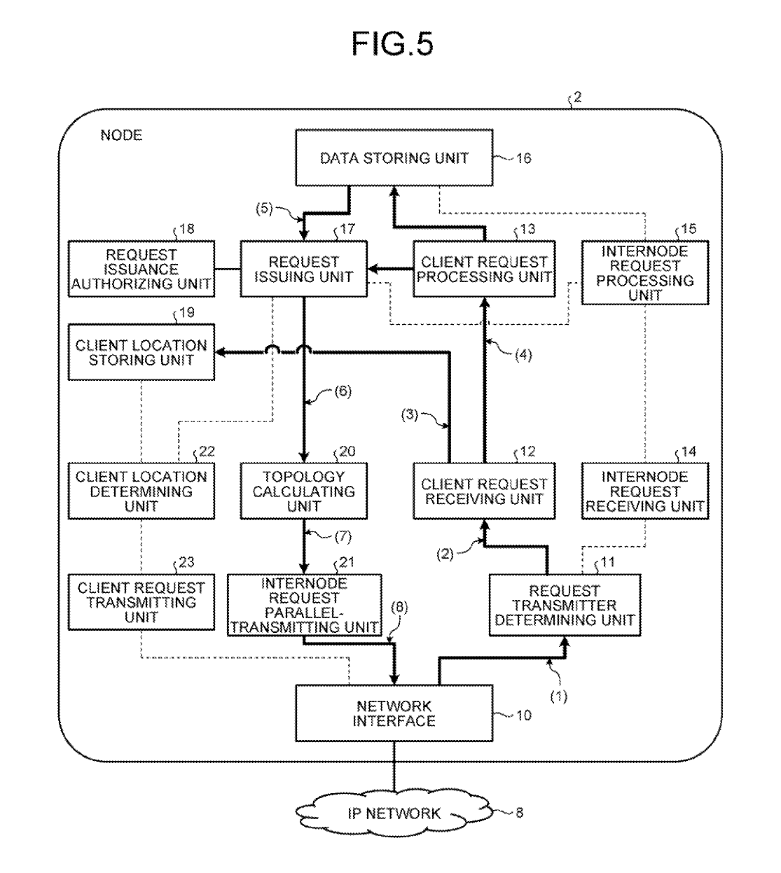

Referring now to FIG. 5, an example operation to be performed by the node 2 serving as a start node when having obtained a “Put” request issued by the client 7 is described. FIG. 5 is a diagram for explaining an example operation to be performed by a start node according to the first embodiment to issue “update” requests. In the example illustrated in FIG. 5, the client 7 has issued a “Put” request for updating the replicas A1 to A4 of the data A.

In the example illustrated in FIG. 5, the node 2 obtains a “Put” request, as indicated by (1) in FIG. 5. In such a case, the request transmitter determining unit 11 outputs the “Put” request to the client request receiving unit 12, as indicated by (2) in FIG. 5. The client request receiving unit 12 stores the location information about the client 7 into the client location storing unit 19 as indicated by (3) in FIG. 5, and outputs the “Put” request to the client request processing unit 13 as indicated by (4) in FIG. 5.

In such a case, the client request processing unit 13 generates updated data of the replica A1 stored in the data storing unit 16, and instructs the request issuing unit 17 to issue an “update” request to update the replicas A1 to A4. In turn, the request issuing unit 17 obtains the location information about the respective nodes 2 to 5 storing the replicas A1 to A4 from the data storing unit 16 as indicated by (5) in FIG. 5, and transmits the “update” request and the location information about the respective nodes 2 to 5 to the topology calculating unit 20 as indicated by (6) in FIG. 5.

In such a case, the topology calculating unit 20 identifies the paths for distributing “update” requests to the respective nodes 2 to 5, based on the location information. The topology calculating unit 20 then outputs the “update” request storing the path information indicating the identified paths to the internode request parallel-transmitting unit 21, as indicated by (7) in FIG. 5. In turn, the internode request parallel-transmitting unit 21 transmits the “update” request to the next node designated by the path information, as indicated by (8) in FIG. 5.

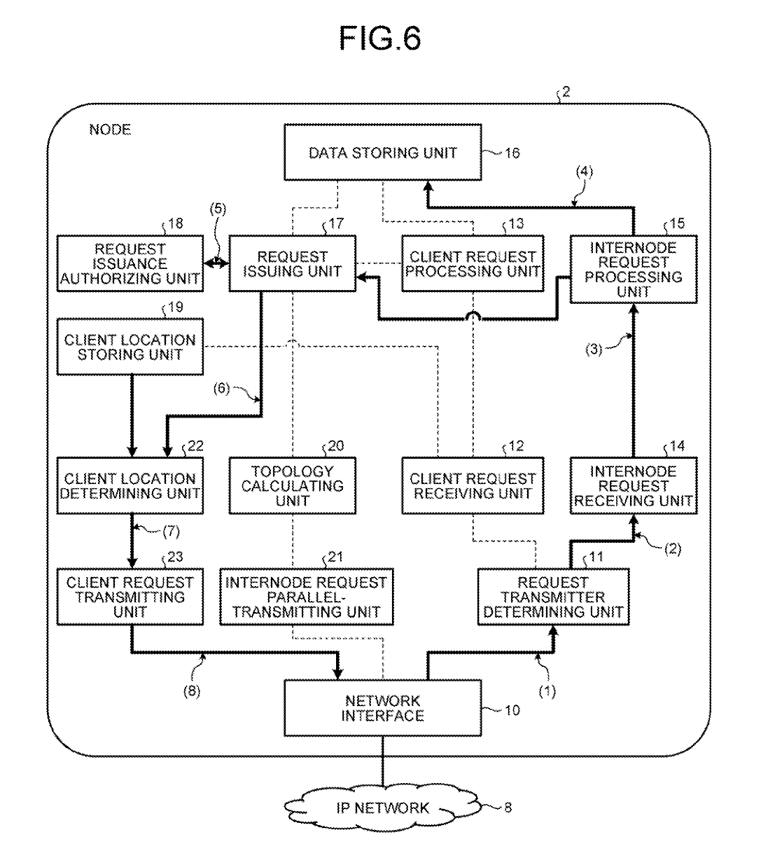

Referring now to FIG. 6, an example operation to be performed by the node 2 serving as a start node when having obtained an “updated” request is described. FIG. 6 is a diagram for explaining an example operation to be performed by a start node according to the first embodiment when having received an “updated” request. For example, when having obtained an “updated” request as indicated by (1) in FIG. 6, the request transmitter determining unit 11 outputs the “updated” request to the internode request receiving unit 14 as indicated by (2) in FIG. 6. In such a case, the internode request receiving unit 14 outputs the “updated” request to the internode request processing unit 15, as indicated by (3) in FIG. 6.

In turn, the internode request processing unit 15 deletes the pre-updated replica A1 from the data storing unit 16 as indicated by (4) in FIG. 6, and instructs the request issuing unit 17 to output a “Put” response. In such a case, the request issuing unit 17 causes the request issuance authorizing unit 18 to determine whether to output a “Put” response, as indicated by (5) in FIG. 6. When having obtained a notification to output a “Put” response, the request issuing unit 17 instructs the client location determining unit 22 to output a “Put” response, as indicated by (6) in FIG. 6.

In turn, the client location determining unit 22 obtains, from the client location storing unit 19, the location information about the client 7 to be the transmission destination of the “Put” response, and outputs the “Put” response and the obtained location information to the client request transmitting unit 23, as indicated by (7) in FIG. 6. In such a case, the client request transmitting unit 23 transmits the “Put” response to the client 7 via the network interface 10 and the IP network 8, as indicated by (8) in FIG. 6.

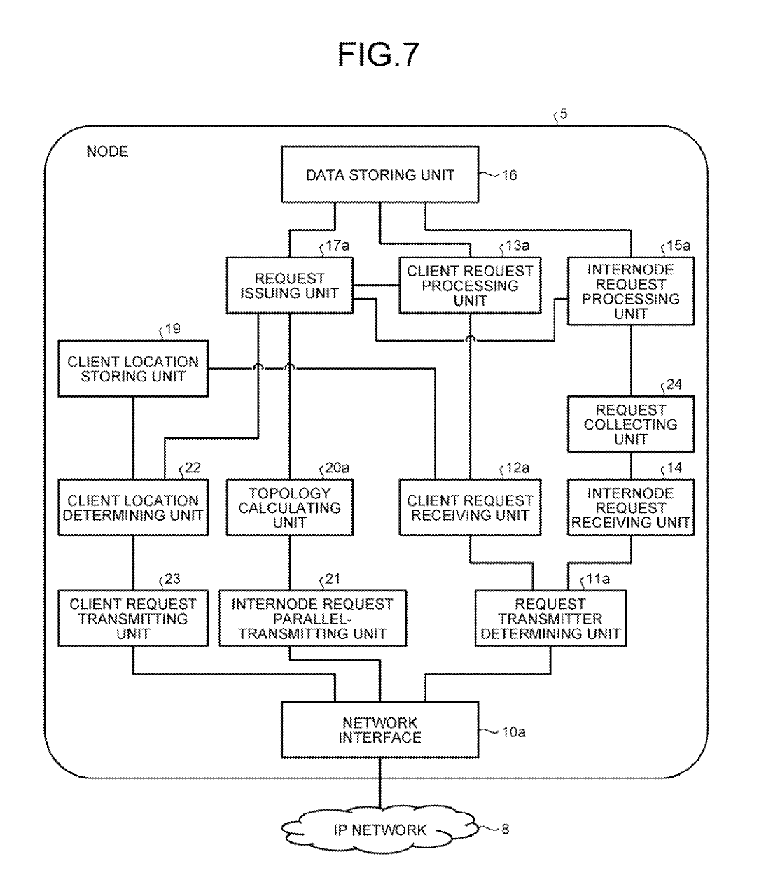

Referring now to FIG. 7, an operation to be performed by the node 5 operating as a terminal node is described. FIG. 7 is a diagram for explaining an example of a terminal node according to the first embodiment. The components having the same functions as those of the respective components 10 to 23 illustrated in FIG. 3 are denoted by the same reference numerals as those used in FIG. 3, and explanation of them will not be repeated below. Each of the other nodes 2 to 4 and the node 6 also includes the respective components illustrated in FIG. 7. That is, each of the nodes 2 to 6 can operate as the terminal node, depending on the stored replicas and the settings in the storage system 1.

In the example illustrated in FIG. 7, the node 5 operating as the terminal node includes a request collecting unit 24 between the internode request receiving unit 14 and an internode request processing unit 15a. Therefore, the internode request receiving unit 14 outputs an “update” request and an “updated” request the node 5 has received from the nodes 3 and 4, to the request collecting unit 24, instead of the internode request processing unit 15a.

A network interface 10a, a request transmitter determining unit 11a, a client request receiving unit 12a, and a client request processing unit 13a have the same functions as the respective components 10 to 13 illustrated in FIG. 3. When having received a “Get” request from the client 7, the network interface 10a, the request transmitter determining unit 11a, and the client request receiving unit 12a transmit the received “Get” request to the client request processing unit 13a.

When having obtained the “Get” request, the client request processing unit 13a retrieves the data of the replica designated in the “Get” request, from the data storing unit 16. The client request processing unit 13a then outputs the retrieved replica data to a request issuing unit 17a, and instructs the request issuing unit 17a to transmit the data to the client 7.

In such a case, the client request processing unit 13a instructs the client request transmitting unit 23 to transmit the obtained data to the client 7, via the client location determining unit 22. The client request transmitting unit 23 then transmits the data to the client 7.

When having obtained an “update” request from the internode request receiving unit 14, the request collecting unit 24 analyzes the path information stored in the obtained “update” request, and determines whether the node 5 is the terminal node of the paths indicated by the path information. If the node 5 is the terminal node of the paths indicated by the path information, the request collecting unit 24 holds the obtained “update” request.

The request collecting unit 24 also analyzes the path information stored in the held “update” request, and determines whether the number of “update” requests that are designed for updating the same replica and are held therein is the same as the number of all the paths indicated by the path information. That is, the request collecting unit 24 determines whether the node 5 has received “update” requests transferred through all the paths.

If the number of “update” requests that are designed for updating the same replica and are held in the request collecting unit 24 is determined to be the same as the number of all the paths indicated by the path information, the request collecting unit 24 outputs one of the “update” requests to the internode request processing unit 15a. If the number of “update” requests that are designed for updating the same replica and are held in the request collecting unit 24 is determined to be smaller than the number of all the paths indicated by the path information, the request collecting unit 24 stands by until receiving the remaining “update” requests.

If the node 5 is not the terminal node of the paths indicated by the path information, the request collecting unit 24 outputs one of the obtained “update” requests to the internode request processing unit 15a, and instructs the internode request processing unit 15a to issue “updated” requests. When having obtained an “updated” request from the internode request receiving unit 14, the request collecting unit 24 outputs the obtained “updated” request to the internode request processing unit 15a.

The internode request processing unit 15a performs the same operation as the internode request processing unit 15 illustrated in FIG. 3. Further, when having obtained an “update” request from the request collecting unit 24 and having been instructed to issue “updated” requests, the internode request processing unit 15a performs the following operation.

That is, the internode request processing unit 15a retrieves, from the data storing unit 16, the data of the replica designated in the “update” request, and stores only updated replica data generated by updating the retrieved data into the data storing unit 16. The internode request processing unit 15a also instructs the request issuing unit 17a to issue “updated” requests, and outputs the path information stored in the “update” request to the request issuing unit 17a.

The request issuing unit 17a has the same functions as the request issuing unit 17 illustrated in FIG. 3. When having been instructed to issue “updated” requests by the internode request processing unit 15a, the request issuing unit 17a generates “updated” requests. The request issuing unit 17a then outputs the generated “updated” requests and the path information obtained from the internode request processing unit 15a, to the topology calculating unit 20.

A topology calculating unit 20a has the same functions as the topology calculating unit 20 illustrated in FIG. 3. When having obtained the “updated” requests and the path information from the request issuing unit 17a, the topology calculating unit 20a performs the following operation. That is, the topology calculating unit 20a generates new path information indicating paths that are the reverse of the paths indicated by the obtained path information. The topology calculating unit 20a then stores the new path information into the header of each obtained “updated” requests, and outputs the “updated” requests to the internode request parallel-transmitting unit 21.

As described above, the node 2 identifies the paths having the node 2 as the start node, and transmits “update” requests to the nodes adjacent to the node 2 in the identified paths. In this manner, the node 2 transmits “update” requests to the respective nodes 2 to 5. As the node 2 transmits “update” requests to the nodes existing in the respective paths in a parallel manner through the respective paths, the time for updating replicas can be shortened.

Also, the node 5 stands by until receiving “update” requests designating the node 5 as the terminal node through all the paths. When having received “update” requests designating the node 5 as the terminal node through all the paths, the node 5 transmits “updated” requests to the start node through all the paths. Accordingly, the storage system 1 can shorten the time for updating replicas, while maintaining strong consistency.

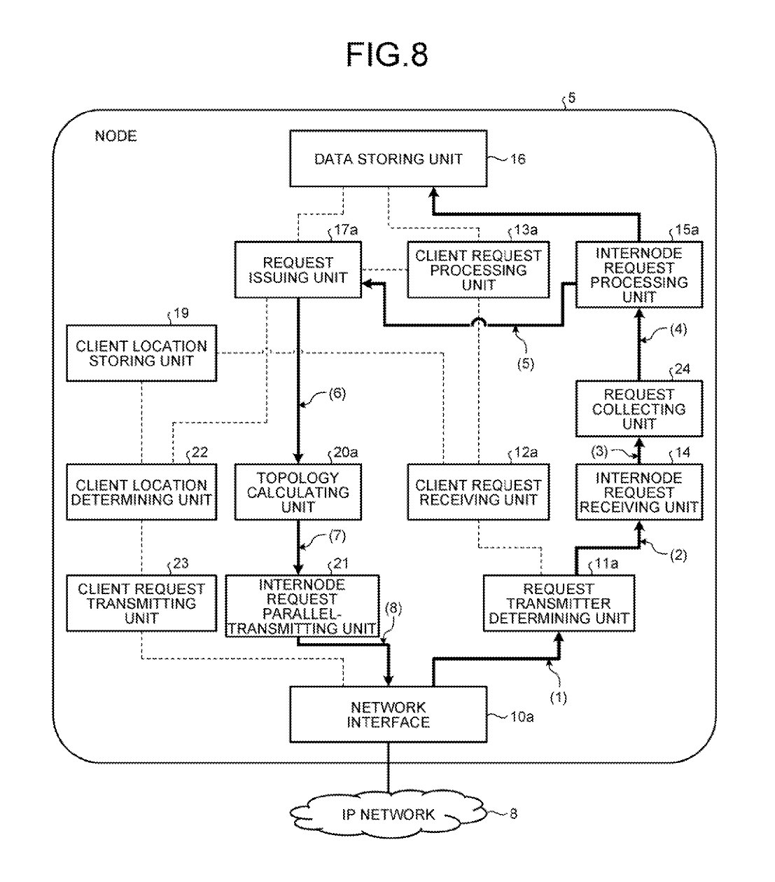

Referring now to FIG. 8, an example operation to be performed by the node 5 serving as the terminal node is described. FIG. 8 is a diagram for explaining an example operation to be performed by a terminal node according to the first embodiment. For example, when having received an “update” request from the other nodes 2 to 6, the network interface 10a outputs the received “update” request to the to the request transmitter determining unit 11, as indicated by (1) in FIG. 8.

The request transmitter determining unit 11a outputs the “update” request to the internode request receiving unit 14, as indicated by (2) in FIG. 8. The internode request receiving unit 14 outputs the “update” request to the request collecting unit 24, as indicated by (3) in FIG. 8. In such a case, the request collecting unit 24 determines whether the request collecting unit 24 has obtained “update” requests for the same replicas through all the paths indicated by the path information stored in the “update” request. When having determined that the request collecting unit 24 have obtained the “update” requests for the same replica through all the paths, the request collecting unit 24 transmits one of the “update” requests to the internode request processing unit 15a, as indicated by (4) in FIG. 8.

The internode request processing unit 15a then updates the replicas stored in the data storing unit 16, and instructs the request issuing unit 17a to issue “updated” requests, as indicated by (5) in FIG. 8. In turn, the request issuing unit 17a generates “updated” requests, and instructs the topology calculating unit 20a to transmit the “updated” requests, as indicated by (6) in FIG. 8.

In such a case, the topology calculating unit 20a identifies new path information indicating paths that are the reverse of all the paths indicated by the path information stored in the “update” request, and stores the new path information into the header of each “updated” request. The topology calculating unit 20a then instructs the internode request parallel-transmitting unit 21 to transmit the “updated” requests, as indicated by (7) in FIG. 8. In such a case, the internode request parallel-transmitting unit 21 transmits the “updated” requests via the network interface 10a, as indicated by (8) in FIG. 8.

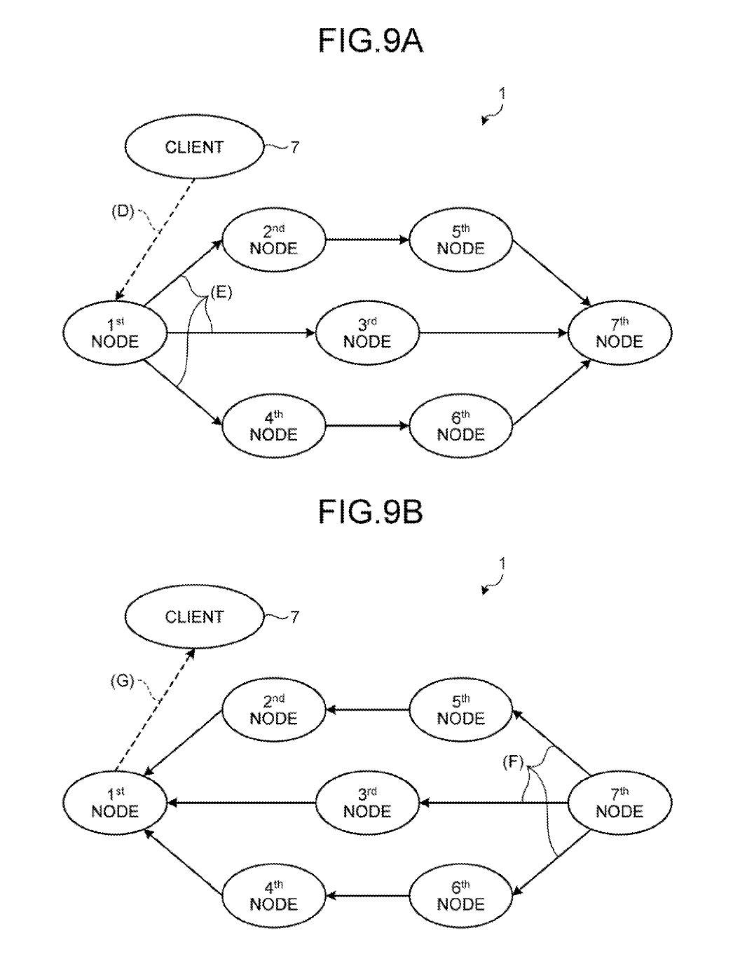

Referring now to FIGS. 9A and 9B, operations to be performed by the storage system 1 according to the first embodiment are described. The operations are performed to sequentially transfer “update” requests from the start node to the terminal node through paths, and sequentially transfer “updated” requests from the terminal node to the start node through the paths.

FIG. 9A is a diagram for explaining the operation to be performed by the storage system according to the first embodiment to transmit “update” requests through the paths. FIG. 9B is a diagram for explaining the operation to be performed by the storage system according to the first embodiment to transmit “updated” requests through the paths. In the examples illustrated in FIGS. 9A and 9B, replicas stored in the seven nodes of 1st to 7th nodes are to be updated.

For example, the client 7 issues a “Put” request to the 1st node, as indicated by (D) in FIG. 9A. In such a case, the 1st node identifies all the nodes storing the replicas designated in the “Put” request, or the 1st to 7th nodes.

In the example illustrated in FIG. 9A, the 1st node identifies three paths each having the 1st node as the start node and the 7th node as the terminal node. Specifically, the 1st node identifies the path connecting the 1st node, the 2nd node, the 5th node, and the 7th node, the path connecting the 1st node, the 3rd node, and the 7th node, and the path connecting the 1st node, the 4th node, and the 6th node.

The 1st node then transmits “update” requests to the 2nd node, the 3rd node, and the 4th node, as indicated by (E) in FIG. 9A. In such a case, the 2nd node transfers the “update” request to the 5th node, and the 5th node transfers the “update” request to the 7th node. The 3rd node transfers the “update” request to the 7th node. The 4th node transfers the “update” request to the 6th node, and the 6th node transfers the “update” request to the 7th node.

Here, the 7th node stands by until receiving the “update” requests through all the three paths illustrated in FIG. 9A. When having determined that the 7th node has received the “update” requests through all the paths, the 7th node generates “updated” requests. The 7th node then transmits the “updated” requests to the 5th node, the 3rd node, and the 6th node, as indicated by (F) in FIG. 9B. In such a case the 2nd to 6th nodes transfer the “updated” requests to the 1st node through the respective paths in a reverse manner. When having obtained an “updated” request through one of the paths, the 1st node transmits a “Put” response to the client 7, as indicated by (G) in FIG. 9B.

At this point, a conventional storage system sequentially transmits an “update” request and an “updated” request through one path from the 1st node to the 7th node, and therefore, performs six transfers. On the other hand, the storage system 1 sequentially transfers “update” requests and “updated” requests through more than one path. In the examples illustrated in FIGS. 9A and 9B, the maximum number of transfers is three. Accordingly, in the examples illustrated in FIGS. 9A and 9B, the storage system 1 can shorten the time for updating to half of the time for updating by the conventional storage system.

The network interfaces 10 and 10a, the request transmitter determining units 11 and 11a, the client request receiving units 12 and 12a, the client request processing units 13 and 13a, the internode request receiving unit 14, and the internode request processing units 15 and 15a are electronic circuits, for example. The request issuing units 17 and 17a, the request issuance authorizing unit 18, the client location storing unit 19, the topology calculating units 20 and 20a, the internode request parallel-transmitting unit 21, the client location determining unit 22, the client request transmitting unit 23, and the request collecting unit 24 are electronic circuits. Here, examples of the electronic circuits include integrated circuits such as ASIC (Application Specific Integrated Circuits) and FPGA (Field Programmable Gate Arrays), CPUs (Central Processing Units), and MPU (Micro Processing Units).

The data storing unit 16 is semiconductor memory such as RAM (Random Access Memory), ROM (Read Only Memory), or flash memory, or a storage device such as a hard disk or an optical disk.

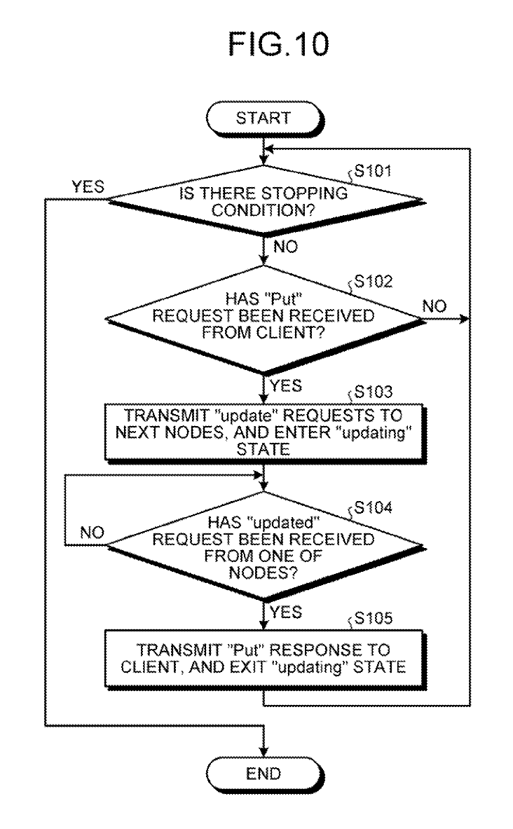

Referring now to FIG. 10, an example of the flow of processing to be performed by a start node is described. FIG. 10 is a flowchart for explaining an example of the flow of processing to be performed by a start node. In the following, example operations to be performed by the node 2 operating as the start node are described.

For example, the node 2 determines whether a stopping condition has occurred in the node 2 (step S101). Here, a stopping condition is a condition that occurs where a “Put” response has not been output after receipt of a “Put” request, for example. In a case where a stopping condition has not occurred (“No” in step S101), the node 2 determines whether the node 2 has received a “Put” request from the client 7 (step S102).

In a case where the node 2 has received a “Put” request from the client 7 (“Yes” in step S102), the node 2 identifies the paths for transmitting “update” requests, and transmits the “update” requests to the next nodes in the respective paths (step S103). During the time between the transmission of the “update” requests and receipt of an “updated” request, the node 2 enters an “updating” state.

The node 2 then determines from which node having transmitted an “update” request the node 2 has received an “updated” request (step S104). In a case where the node 2 has not received an “updated” request (“No” in step S104), the node 2 stands by until receiving an “updated” request (step S104). In a case where the node 2 has received an “updated” request from one of the nodes (“Yes” in step S104), the node 2 transmits a “Put” response to the client, and exits the “updating” state (step S105). The node 2 then determines whether a stopping condition has occurred therein (step S101).

In a case where the node 2 has not received a “Put” request from the client (“No” in step S102), the node 2 again determines whether a stopping condition has occurred therein (step S101). In a case where a stopping condition has occurred (“Yes” in step S101), the node 2 stops the operations until the stopping condition is eliminated.

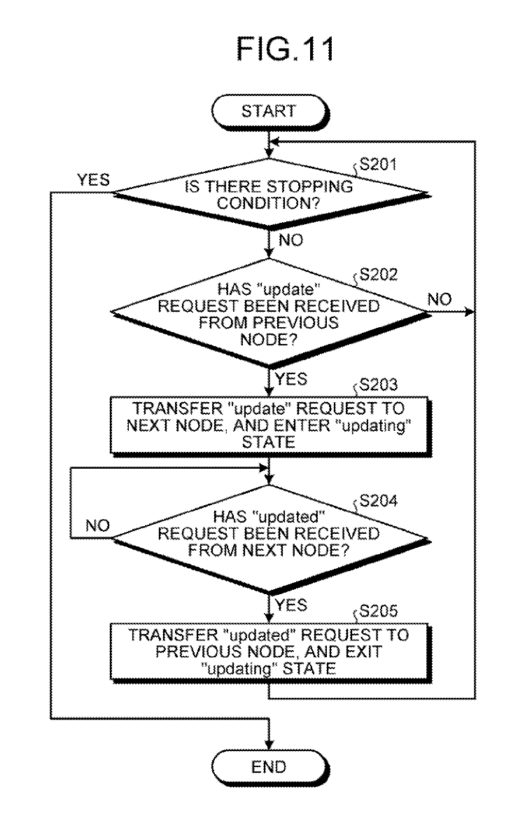

Referring now to FIG. 11, an example of the flow of processing to be performed by an intermediate node of each path is described. FIG. 11 is a flowchart for explaining an example of the flow of processing to be performed by an intermediate node. In the following, example operations to be performed by the node 3 operating as an intermediate node are described.

For example, the node 3 determines whether a stopping condition has occurred therein (step S201). In a case where the node 3 determines that a stopping condition has not occurred therein (“No” in step S201), the node 3 determines whether the node 3 has received an “update” request (step S202). In a case where the node 3 has received an “update” request from the previous node in the path (“Yes” in step S202), the node 3 transfers the “update” request to the next node in the path, and enters an “updating” state (step S203).

The node 3 then stands by until receiving an “updated” request from the next node to which the node 3 has transferred the “update” request (“No” in step S204). In a case where the node 3 has received an “updated” request (“Yes” in step S204), the node 3 performs the following operation. That is, the node 3 transfers the “updated” request to the previous node in the path, and exits the “updating” state (step S205).

After that, the node 3 again determines whether a stopping condition has occurred therein (step S201). In a case where a stopping operation has occurred therein (“Yes” in step S201), the node 3 stops the operations until the stopping condition is eliminated. In a case where the node 3 has not received an “update” request from the previous node (“No” in step S202), the node 3 again determines whether a stopping condition has occurred therein (step S201).

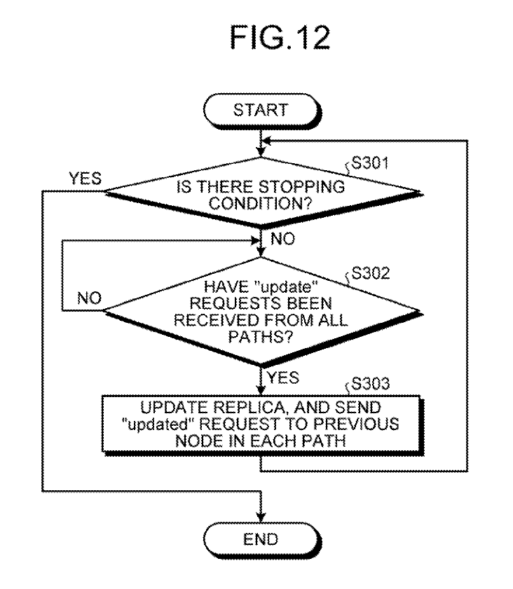

Referring now to FIG. 12, an example of the flow of processing to be performed by a terminal node is described. FIG. 12 is a flowchart for explaining an example of the flow of processing to be performed by a terminal node. In the following, example operations to be performed by the node 5 operating as the terminal node are described.

First, the node 5 determines whether a stopping condition has occurred therein (step S301). In a case where a stopping condition has not occurred therein (“No” in step S301), the node 5 determines whether the node 5 has received “update” requests through all the paths having the node 5 as the terminal node (step S302). In a case where the node 5 has not received “update” requests through all the paths having the node 5 as the terminal node (“No” in step S302), the node 5 stands by until receiving “update” requests through all the paths (step S302).

In a case where the node 5 has received “update” requests through all the paths having the node 5 as the terminal node (“Yes” in step S302), the node 5 updates the replica, and transmits “updated” requests to the previous nodes in the respective paths (step S303). After that, the node 5 again determines whether a stopping condition has occurred therein (step S301). In a case where a stopping condition has occurred therein (“Yes” in step S301), the node 5 stops the operations until the stopping condition is eliminated.

Advantages of the Storage System 1

As described above, when having received a “Put” request for the replicas A1 to A4 from the client 7, the node 2 identifies the paths that have the node 2 as the start point and connect the nodes 2 to 5 in series. The node 2 transmits “update” requests to the node 5 as the terminal node of each of the paths, through the identified paths. After that, when having received an “updated” request through one of the paths, the node 2 transmits a “Put” response to the client 7.

Therefore, the node 2 transfers “update” requests and “updated” requests among the respective nodes 2 to 5, through more than one path. Accordingly, the time for updating the replicas A1 to A4 can be shortened.

The node 2 also stores the installation locations of the respective nodes 2 to 6, and identifies the paths series-connecting storage devices installed at locations close to one another. Accordingly, the node 2 can efficiently transfer “update” requests and “updated” requests to the nodes included in the respective paths. As a result, the time for updating each of the replicas A1 to A4, B1 to B4, and C1 to C4 can be shortened.

The node 2 also identifies the paths each having the node 5 as the terminal node. Accordingly, the node 2 can easily maintain strong consistency.

The node 5 determines whether the node 5 has received “update” requests through all the paths each having the node 5 as the terminal path, and stands by until receiving “update” requests through all the paths. When having received “update” requests through all the paths, the node 5 transmits “updated” requests to the node 2 as the start node through the respective paths. Accordingly, the node 5 can transfer “update” requests and “updated” requests through the paths, while maintaining strong consistency.

### [b] Second Embodiment

Next, a storage system according to a second embodiment is described. In the storage system 1 according to the first embodiment, for example, “update” requests and “updated” requests are sequentially transferred through paths having the same node as the terminal node. However, embodiments are not limited to that.

For example, if the number of transfers of “update” requests and “updated” requests through respective paths can be reduced where the terminal nodes of the respective paths are different, the time for updating can be shortened. In the following, a storage system 1a having different nodes as the terminal nodes of respective paths is described.

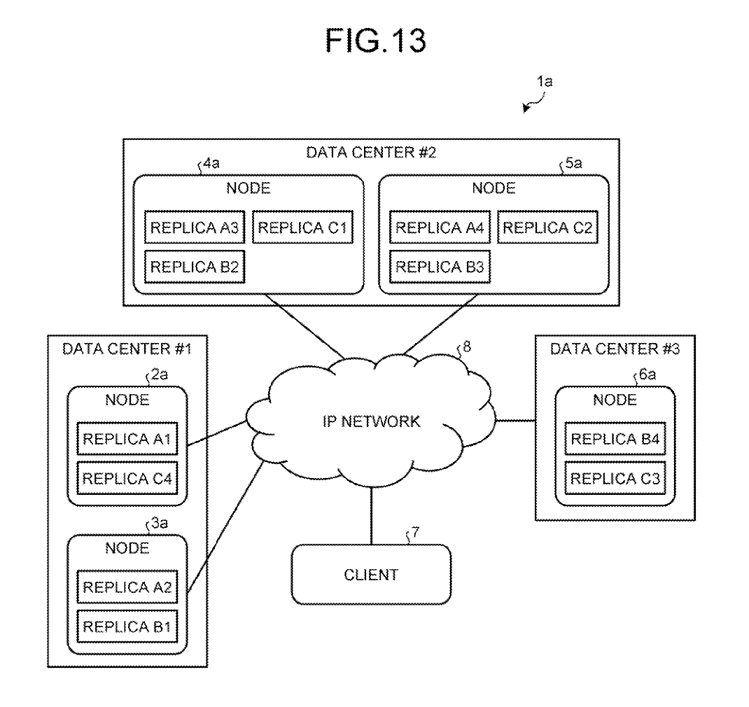

FIG. 13 is a diagram for explaining an example of the storage system according to the second embodiment. In the example illustrated in FIG. 13, the storage system 1a includes nodes 2a to 6a in data centers #1 to #3, like the storage system 1. A client 7 and an IP network 8 illustrated in FIG. 13 have the same functions as the client 7 and the IP network 8 according to the first embodiment, and therefore, explanation of them will not be repeated.

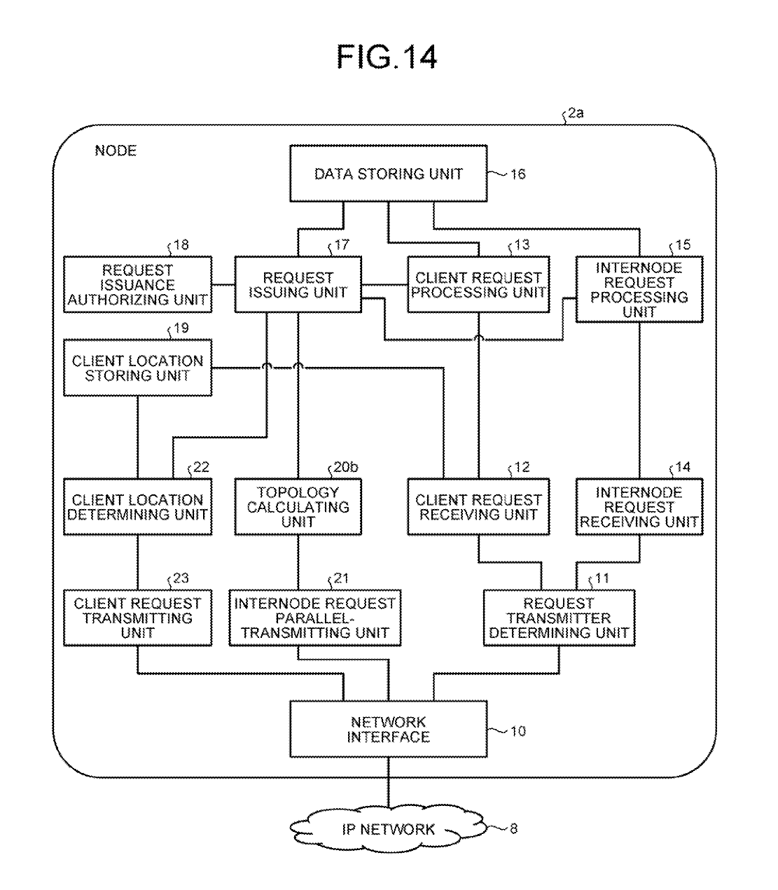

FIG. 14 is a diagram for explaining an example of a start node according to the second embodiment. In the example illustrated in FIG. 14, an example of the node 2a is the start node. The other nodes 3a to 6a also have the same functions as the node 2a. Of the components of the node 2a illustrated in FIG. 14, those having the same functions as components of the node 2 illustrated in FIG. 3 are denoted by the same reference numerals as those used in FIG. 3, and explanation of them will not be repeated below.

A topology calculating unit 20b has the same functions as the topology calculating unit 20a according to the first embodiment. In a case where the time for updating can be made shorter by using different nodes as the terminal nodes of respective paths, the topology calculating unit 20b identifies the paths having different terminal nodes from one another.

The topology calculating unit 20b stores path information indicating the identified paths into each “update” request. For example, the topology calculating unit 20b stores, into each “update” request, path information indicating the path having the node 2a as the start node and the node 3a as the terminal node, and the path having the node 2a as the start node, the node 4a as the intermediate node, and the node 5a as the terminal node.

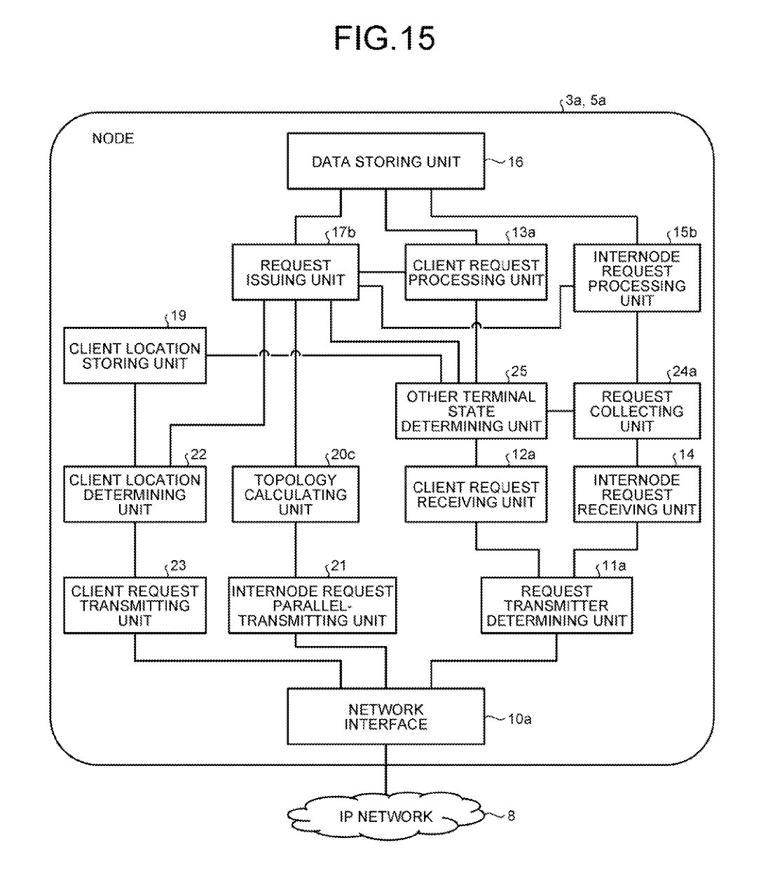

Referring now to FIG. 15, an example of a terminal node according to the second embodiment is described. FIG. 15 is a diagram for explaining an example of a terminal node according to the second embodiment. In the following, an example case where the node 3a and the node 5a are terminal nodes is described. The other nodes 2a, 4a, and 6a can also have the same functions as the nodes 3a and 5a. Of the components of the nodes 3a and 5a illustrated in FIG. 15, the components having the same functions as the node 5 illustrated in FIG. 7 are denoted by the same reference numerals as those used in FIG. 7, and explanation of them will not be repeated below.

A request collecting unit 24a has the same functions as the request collecting unit 24. Where the request collecting unit 24a has received “update” requests through all the paths having its own node as the terminal node, the request collecting unit 24a does not output any “update” request to an internode request processing unit 15b, but performs the following operation.

That is, the request collecting unit 24a instructs the internode request processing unit 15b to transmit “readyToUpdate” requests to the other terminal nodes to notify that the “update” requests have been received. At this point, the request collecting unit 24a notifies the internode request processing unit 15b of the path information stored in the “update” requests.

The request collecting unit 24a also obtains a “readyToUpdate” request issued from another terminal node via a network interface 10a, a request transmitter determining unit 11a, and an internode request receiving unit 14. The request collecting unit 24a then determines whether the request collecting unit 24a has obtained “readyToUpdate” requests from all the other terminal nodes.

When having determined that the request collecting unit 24a has obtained “readyToUpdate” requests from all the other terminal nodes, the request collecting unit 24a outputs one of the obtained “update” requests to the internode request processing unit 15b. When having determined that the request collecting unit 24a has not obtained “readyToUpdate” requests from all the other terminal nodes, the request collecting unit 24a stands by until obtaining “readyToUpdate” requests from all the other terminal nodes.

In short, where the request collecting unit 24a has obtained “update” requests through all the paths having its own node as the terminal node, the request collecting unit 24a transmits “readyToUpdate” requests to the terminal nodes of the other paths. Where the request collecting unit 24a has obtained “readyToUpdate” requests from all the terminal nodes, and has obtained “update” requests through all the paths having its own node as the terminal node, the request collecting unit 24a performs the following operation. That is, the request collecting unit 24a transmits “updated” requests to the start node through all the paths having its own node as the terminal node.

The internode request processing unit 15b has the same functions as the internode request processing unit 15a illustrated in FIG. 7. When having obtained the path information from the request collecting unit 24a and having been instructed to issue “readyToUpdate” requests, the internode request processing unit 15b performs the following operation. That is, the internode request processing unit 15b outputs the path information to a request issuing unit 17b, and instructs the request issuing unit 17b to issue “readyToUpdate” requests.

The internode request processing unit 15b also retrieves the data of the replica to be updated from the data storing unit 16, and generates updated data by updating the retrieved data. The internode request processing unit 15b stores the updated replica data, as well as the pre-updated replica data, into the data storing unit 16.

When having obtained an “update” request from the request collecting unit 24a, the internode request processing unit 15b deletes the pre-updated replica data from the data storing unit 16. The internode request processing unit 15b then instructs the request issuing unit 17b to issue “updated” requests, and outputs the path information stored in the “update” request.

An other terminal state determining unit 25 obtains a “Get” request that is output from a client request receiving unit 12a. In such a case, the other terminal state determining unit 25 determines whether the request collecting unit 24a has received “update” requests through all the paths having its own node as the terminal node. Where the other terminal state determining unit 25 has determined that “update” requests have not been received through all the paths having its own node as the terminal node, the other terminal state determining unit 25 instructs a client request processing unit 13a to output pre-updated replica data to the client 7.

Where the request collecting unit 24a has received “update” requests through all the paths having its own node as the terminal node, the other terminal state determining unit 25 determines whether “readyToUpdate” requests have been received from all the terminal nodes. When having determined that the request collecting unit 24a has received “readyToUpdate” requests from all the terminal nodes, the other terminal state determining unit 25 instructs the client request processing unit 13a to output updated replica data.

When having determined that the request collecting unit 24a has not received “readyToUpdate” requests from all the terminal nodes, the other terminal state determining unit 25 performs the following operation. That is, the other terminal state determining unit 25 instructs the client request processing unit 13a to inquire of the other terminal nodes about whether “updated” request issuance has been requested.

When having received a response indicating that “updated” request issuance has been requested from one of the terminal nodes, the other terminal state determining unit 25 instructs the client request processing unit 13a to output updated replica data to the client 7. When having not received a response indicating that “updated” request issuance has been requested from any of the terminal nodes, the other terminal state determining unit 25 instructs the client request processing unit 13a to output pre-updated replica data.

Where the other terminal state determining unit 25 has received “update” requests through all the paths having its own node as the terminal node, and one of the terminal nodes including its own node has requested “updated” request issuance, the other terminal state determining unit 25 outputs updated replica data in response to the “Get” response. While inquiring of the other terminal nodes about whether an “updated” request has been transmitted, the other terminal state determining unit 25 cancels the inquiry when the request collecting unit 24a has obtained “readyToUpdate” requests from all the terminal nodes. The other terminal state determining unit 25 then instructs the client request processing unit 13a to output updated replica data.

The request collecting unit 24a obtains inquiries transmitted from the other terminal nodes via the network interface 10a, the request transmitter determining unit 11a, and the client request receiving unit 12a. In such a case, the request collecting unit 24a instructs the internode request processing unit 15b to send a response to inform the terminal nodes as the inquirers of whether its own node has requested “updated” request issuance. In such a case, the response is transmitted to the terminal nodes as the inquirers via the request issuing unit 17b, a topology calculating unit 20c, and an internode request parallel-transmitting unit 21.

The request issuing unit 17b has the same functions as the request issuing unit 17a illustrated in FIG. 7. When having obtained the path information and having been instructed to issue “readyToUpdate” requests, the request issuing unit 17b generates “readyToUpdate” requests. The request issuing unit 17b outputs the “readyToUpdate” requests, as well as the obtained path information, to the topology calculating unit 20c.

The topology calculating unit 20c has the same functions as the topology calculating unit 20a illustrated in FIG. 7. When having obtained the “readyToUpdate” requests as well as the path information, the topology calculating unit 20c analyzes the obtained path information, to identify all the terminal nodes other than its own node. After that, the topology calculating unit 20c instructs the internode request parallel-transmitting unit 21 to transmit the “readyToUpdate” requests to all the identified terminal nodes.

Where the node 3a and the node 5a have received “update” requests through all the paths having their own nodes as the terminal nodes, the node 3a and the node 5a transmit “readyToUpdate” requests to the other terminal nodes. Where the node 3a and the node 5a have received “update” requests through all the paths having their own nodes as the terminal nodes and have received “readyToUpdate” requests from all the other terminal nodes, the node 3a and the node 5a transmit “updated” requests. Accordingly, even if the terminal nodes of the paths for transferring “update” requests and “updated” requests are different from one another, the storage system 1a can shorten the time for updating replicas while maintaining strong consistency.

Where the node 3a and the node 5a have received a “Get” request during the time between receipt of “update” requests through all the paths having their own nodes as the terminal nodes and receipt of “readyToUpdate” from all the other terminal nodes, the node 3a and the node 5a perform the following operation. That is, the node 3a and the node 5a inquire of the other terminal nodes about whether an “updated” request has been issued, and determines whether there is a terminal node that has issued an “updated” request. If there is a terminal node that has issued an “updated” request, the node 3a and the node 5a output updated replica data. If there is not a terminal node that has issued an “updated” request, the node 3a and the node 5a output pre-updated replica data.

Accordingly, even if a “Get” request is issued while a replica is being updated, the storage system 1a can transmit data in accordance with the update state in each path to the client. As a result, the storage system 1a can shorten the time for updating replicas while maintaining strong consistency.

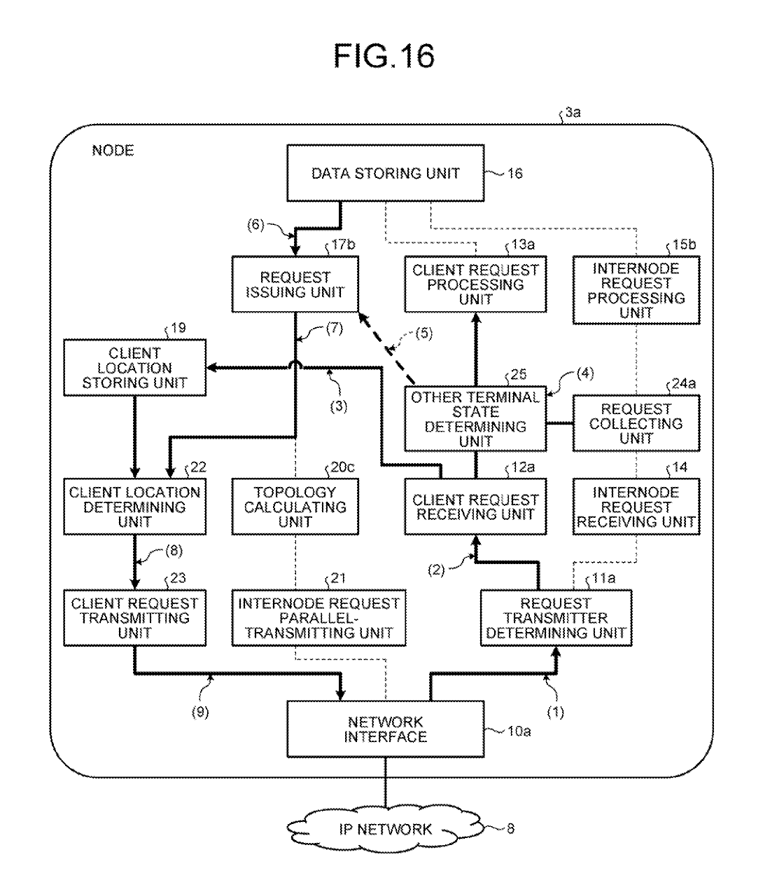

Referring now to FIG. 16, an example operation to be performed by the node 3a and the node 5a as the terminal nodes upon receipt of a “Get” request from the client 7 is described. FIG. 16 is a diagram for explaining an example operation to be performed by a terminal node according to the second embodiment upon receipt of a “Get” request. In the example illustrated in FIG. 16, the client 7 has issued a “Get” request concerning a replica A2 of data A to the node 3a.

First, as indicated by (1) in FIG. 16, the network interface 10a outputs a “Get” request to the request transmitter determining unit 11a. In such a case, the request transmitter determining unit 11a outputs the “Get” request to the client request receiving unit 12a, as indicated by (2) in FIG. 16. In turn, the client request receiving unit 12a stores the location information about the client 7 into the client location storing unit 19, as indicated by (3) in FIG. 16. The client request receiving unit 12a also outputs the “Get” request to the other terminal state determining unit 25.

The other terminal state determining unit 25 then determines whether the request collecting unit 24a has obtained “update” requests through all the paths having the node 3a as the terminal, as indicated by (4) in FIG. 16. In a case where the request collecting unit 24a has not obtained “update” requests through all the paths having the node 3a as the terminal, the other terminal state determining unit 25 instructs the client request processing unit 13a to output pre-updated replica data.

In a case where the request collecting unit 24a has obtained “update” requests through all the paths having the node 3a as the terminal, the other terminal state determining unit 25 determines whether the request collecting unit 24a has obtained “readyToUpdate” requests from all the terminal nodes. In a case where the request collecting unit 24a has not obtained “readyToUpdate” requests from all the terminal nodes, the other terminal state determining unit 25 sends an instruction to inquire of the other terminal nodes, as indicated by (5) in FIG. 16.

When having obtained a response indicating that an “updated” request has been transmitted from one of the terminal nodes, the other terminal state determining unit 25 instructs the client request processing unit 13a to output updated replica data. In a case where the request collecting unit 24a has obtained “readyToUpdate” requests from all the terminal nodes, the other terminal state determining unit 25 also instructs the client request processing unit 13a to output updated replica data. The client request processing unit 13a then instructs the request issuing unit 17b to output the updated replica data.

In such a case, the request issuing unit 17b obtains the updated replica data as indicated by (6) in FIG. 16, and outputs the obtained data to the client location determining unit 22 as indicated by (7) in FIG. 16. In turn, the client location determining unit 22 obtains, from the client location storing unit 19, the location information about the client 7, which is the issuer of the “Get” request. The client location determining unit 22 then outputs the replica data and the location information about the client 7 to the client request transmitting unit 23, as indicated by (8) in FIG. 16. In such a case, the client request transmitting unit 23 transmits the replica data to the client 7 via the network interface 10a, as indicated by (9) in FIG. 16.

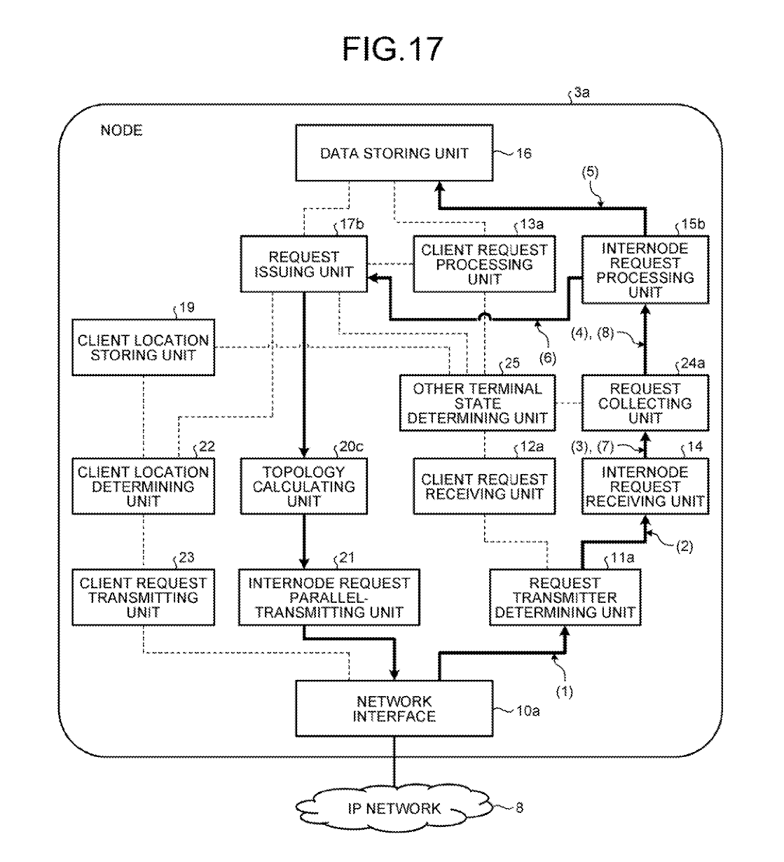

Referring now to FIG. 17, an example operation to be performed by the node 3a upon receipt of an “update” request is described. FIG. 17 is a diagram for explaining an example operation to be performed by a terminal node according to the second embodiment upon receipt of an “update” request. For example, the network interface 10a transmits a received “update” request to the request transmitter determining unit 11a, as indicated by (1) in FIG. 17. In such a case, the request transmitter determining unit 11a outputs the “update” request to the internode request receiving unit 14 as indicated by (2) in FIG. 17, and the internode request receiving unit 14 outputs the “updated” request to the request collecting unit 24a as indicated by (3) in FIG. 17.

At this point, the request collecting unit 24a stands by until obtaining “update” requests through all the paths having the node 3a as the terminal node, like the request collecting unit 24. When having obtained “update” requests through all the paths having the node 3a as the terminal node, the request collecting unit 24a instructs the internode request processing unit 15b to transmit a “readyToUpdate” request, as indicated by (4) in FIG. 17.

In such a case, the internode request processing unit 15b stores updated replica data into the data storing unit 16, as indicated by (5) in FIG. 17. The internode request processing unit 15b also instructs the request issuing unit 17b to issue a “readyToUpdate” request, as indicated by (6) in FIG. 17. In this case, the request issuing unit 17b, the topology calculating unit 20c, and the internode request parallel-transmitting unit 21 transmit a “readyToUpdate” request to the node 5a, which is another terminal node.

When having obtained a “readyToUpdate” request via the network interface 10a, the request transmitter determining unit 11a, and the internode request receiving unit 14 as indicated by (7) in FIG. 17, the request collecting unit 24a performs the following operation. That is, the request collecting unit 24a determines whether the request collecting unit 24a has obtained “readyToUpdate” requests from all the terminal nodes other than the node 3a.

When having determined that the request collecting unit 24a has received “readyToUpdate” requests from all the terminal nodes other than the node 3a, the request collecting unit 24a transmits one of the received “update” requests to the internode request processing unit 15b, as indicated by (8) in FIG. 17. Thereafter, the node 3a performs the same operation as the node 5 according to the first embodiment, and sequentially transfers “updated” requests to the start node through all the paths having the node 3a as the terminal.

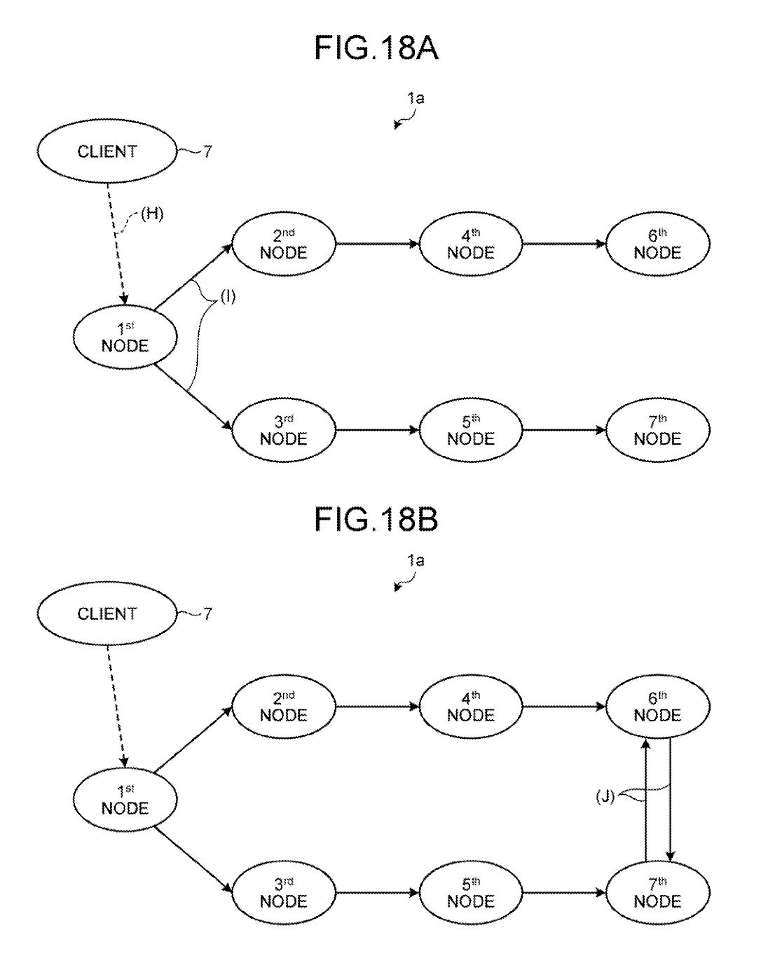

Referring now to FIGS. 18A to 18D, operations to be performed by the storage system 1a according to the second embodiment to sequentially transfer “update” requests and “updated” requests through paths having different terminal nodes from one another are described. In the examples illustrated in FIGS. 18A to 18D, replicas stored in the seven nodes of 1st to 7th nodes are to be updated as in FIGS. 9A and 9B.

FIG. 18A is a diagram for explaining an operation to be performed by the storage system according to the second embodiment to transmit “update” requests through more than one path. FIG. 18B is a diagram for explaining an operation to be performed by a terminal node according to the second embodiment to transmit and receive “readyToUpdate” requests. FIG. 18C is a diagram for explaining an operation to be performed by the storage system according to the second embodiment to transmit “updated” requests. FIG. 18D is a diagram for explaining an operation in the storage system according to the second embodiment.

First, as indicated by (H) in FIG. 18A, the client 7 issues a “Put” request to the 1st node as the start node. In such a case, the 1st node identifies the path connecting the 2nd node, the 4th node, and the 6th node, and the path connecting the 3rd node, the 5th node, and the 7th node, as illustrated in FIG. 18A.

As indicated by (I) in FIG. 18A, the 1st node then transmits “update” requests to the 2nd node and the 3rd node. In such a case, the 2nd node transfers the “update” request to the 4th node, and the 4th node transfers the “update” request to the 6th node. Also, the 3rd node transfers the “update” request to the 5th node, and the 5th node transfers the “update” request to the 7th node.

When having received an “update” request, each of the 6th node and the 7th node as the terminal nodes of the respective paths transmits a “readyToUpdate” request to the terminal node of the other path, as indicated by (J) in FIG. 18B. Through this operation, the 6th node and the 7th node, which are the terminal nodes of the respective paths, can determine whether an “update” request has been transferred through the nodes in each other path.

When having obtained a “readyToUpdate” request from each other terminal node, the 6th node and the 7th node as the terminal nodes of the respective paths transmit “updated” requests to the 4th node and the 5th node, as indicated by (K) in FIG. 18C. When having obtained an “updated” request through one of the paths as indicated by (L) in FIG. 18C, the 1st node transmits a “Put” response to the client 7.

That is, by exchanging “readyToUpdate” requests, the 6th node and the 7th node can operate as if there were a virtual terminal node serving as the terminal node of each path, as indicated by (M) in FIG. 18D. By performing such an operation, the storage system 1a can maintain strong consistency even if the terminal nodes of the respective paths are different nodes.

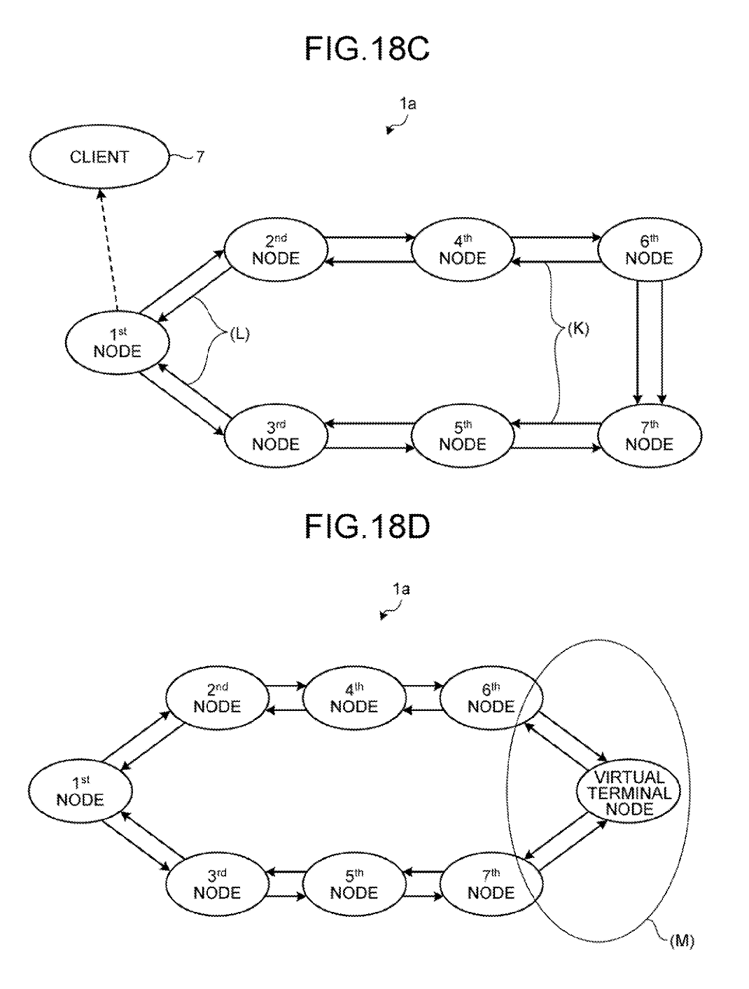

Each of the 6th node and the 7th node as the terminal nodes of the respective paths can also operate as the terminal node of more than one path. FIG. 19 is a diagram for explaining an example operation to be performed by a terminal node of more than one path. In the example illustrated in FIG. 19, the 6th node is not only the terminal node of the path connecting the 1st node, the 2nd node, the 4th node, and the 6th node as illustrated in FIGS. 18A to 18D, but also the terminal node of the path connecting the 1st node, an 8th node, a 9th node, and the 6th node.

In such a case, the 6th node stands by until obtaining “update” requests through the two paths each having the 6th node as the terminal node, as indicated by (N) in FIG. 19. When having obtained “update” requests through the two paths, the 6th node transmits a “readyToUpdate” request to the 7th node, as indicated by (0) in FIG. 19. Through this operation, the storage system 1a can transmit “update” requests and “updated” requests to the respective nodes through paths with arbitrary topologies.

The internode request processing unit 15b, the request issuing unit 17b, the topology calculating unit 20c, the request collecting unit 24a, and the other terminal state determining unit 25 are electronic circuits, for example. Here, examples of the electronic circuits include integrated circuits such as ASIC (Application Specific Integrated Circuits) and FPGA (Field Programmable Gate Arrays), CPUs (Central Processing Units), and MPU (Micro Processing Units).

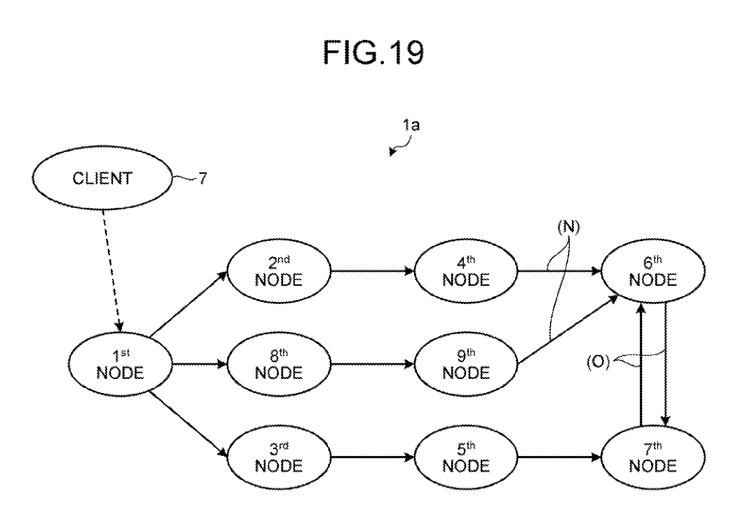

Referring now to FIG. 20, an example of the flow of processing to be performed by a terminal node is described. FIG. 20 is a flowchart for explaining the flow of processing to be performed by a terminal node according to the second embodiment. In the following, an example operation to be performed by the node 3a operating as a terminal node is described.

For example, the node 3a determines whether a stopping condition has occurred therein (step S401). In a case where the node 3a determines that a stopping condition has not occurred therein (“No” in step S401), the node 3a determines whether the node 3 has received “update” requests through all the paths each having the node 3a as the terminal node (step S402). In a case where the node 3a determines that the node 3a has not received “update” requests through all the paths each having the node 3a as the terminal node (“No” in step S402), the node 3a stands by until receiving “update” requests through all the paths (step S402).

When having received “update” requests through all the paths each having the node 3a as the terminal node (“Yes” in step S402), the node 3a transmits a “readyToUpdate” request to each terminal node, and enters a “readyToUpdate” awaiting state (step S403). Here, the “readyToUpdate” awaiting state is a state where “update” requests have been received through all the paths each having its own node as the terminal node, but “readyToUpdate” requests have not been received from the other terminal nodes.

The node 3a also determines whether the node 3a has received “readyToUpdate” requests from all the terminal nodes (step S404). In a case where the node 3a determines that the node 3a has not received “readyToUpdate” requests from all the terminal nodes (“No” in step S404), the node 3a stands by until receiving “readyToUpdate” requests from all the terminal nodes (step S404).

When having received “readyToUpdate” requests from all the terminal nodes (“Yes” in step S404), the node 3a updates the replica and transmits “updated” requests to the previous nodes in all the paths each having the node 3 as the terminal node (step S405). At this point, the node 3a exits the “readyToUpdate” awaiting state. After that, the node 3a again determines whether a stopping condition has occurred (step S401). In a case where a stopping condition has occurred (“Yes” in step S401), the node 3a stops the operation until the stopping condition is eliminated.

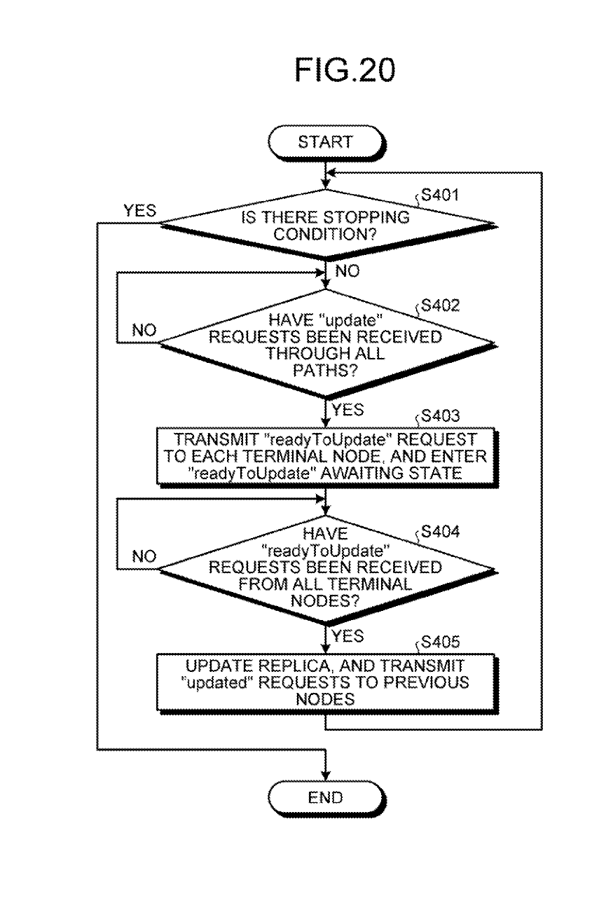

Referring now to FIG. 21, an example of the flow of processing to be performed by a terminal node upon receipt of a “Get” request is described. FIG. 21 is a flowchart for explaining an example of the flow of processing to be performed in response to a “Get” request. In the following, an example of the flow of processing to be performed by the node 3a operating as a terminal node is described.

First, the node 3a determines whether a stopping condition has occurred (step S501). In a case where a stopping condition has not occurred (“No” in step S501), the node 3a determines whether the node 3a has received a “Get” request from the client 7 (step S502). In a case where the node 3 has received a “Get” request from the client 7 (“Yes” in step S502), the node 3 determines whether the node 3 is in a “readyToUpdate” awaiting state (step S503). That is, the node 3a determines whether the node 3a has received “readyToUpdate” requests from all the other terminal nodes.

If the node 3a determines that the node 3a is in the “readyToUpdate” awaiting state (“Yes” in step S503), the node 3a inquires of the other terminal nodes (step S504). The node 3a then determines which terminal node has exited the “readyToUpdate” state and has requested issuance of an “updated” request (step S505).

If the node 3a determines that any terminal node has not requested issuance of an “updated” request (“No” in step S505), the node 3a transmits pre-updated replica data to the client 7 (step S506). If the node 3a determines that one of the terminal nodes has requested issuance of an “updated” request (“Yes” in step S505), the node 3a transmits updated replica data to the client 7 (step S507). After that, the node 3a again determines whether a stopping condition has occurred (step S501). In a case where a stopping condition has occurred (“Yes” in step S501), the node 3a stops the operation until the stopping condition is eliminated.

In a case where the node 3a has received a “Get” request (“Yes” in step S502) and determines that the node 3a is not in the “readyToUpdate” awaiting state (“No” in step S503), the node 3a transmits stored replica data to the client 7 (step S508).

In short, in a case where the node 3a has not received “update” requests through all the paths each having the node 3a as the terminal node, the node 3a has not stored updated replica data, and therefore, transmits the pre-updated replica data. In a case where the node 3a has received “readyToUpdate” requests from all the terminal nodes, the node 3a has stored only updated replica data, and therefore, transmits the updated replica data.

In a case where the node 3a has not received a “Get” request (“No” in step S502), the node 3a again determines whether a stopping condition has occurred (step S501).

Advantages of the Storage System 1a

As described above, when having received “update” requests through all the paths having the node 3a as the terminal node, the node 3a operating as a terminal node transmits “readyToUpdate” requests to the terminal nodes of the paths other than the paths having the node 3a as the terminal node. The node 3a then determines whether the node 3a has received “readyToUpdate” requests from all the terminal nodes other than the node 3a. When having received “readyToUpdate” requests from all the terminal nodes other than the node 3a, the node 3a transmits “updated” requests to the start node through all the paths having the node 3a as the terminal node.

Accordingly, the storage system 1a having the node 3a can transmit “update” requests to the respective nodes through the paths having different terminal nodes from one another. As a result, the storage system 1a can further shorten the time for updating replicas. For example, depending on the installation locations of the respective nodes 2a to 6a, there are cases where the time for updating can be made shorter by transmitting “update” requests through paths having different terminal nodes than by transmitting “update” requests through paths having one terminal node as the common terminal node. In such a case, the storage system 1a can also shorten the time for updating replicas.

When having received a “Get” request from the client 7, the node 3a determines whether the node 3a is in the “readyToUpdate” awaiting state. If the node 3a is in the “readyToUpdate” awaiting state, the node 3a determines whether any other terminal node has requested issuance of an “updated” request. In a case where one of the terminal nodes has requested issuance of an “updated” request, the node 3a transmits updated replica data to the client 7. In a case where any of the terminal nodes has not requested issuance of an “updated” request, the node 3a transmits the pre-updated replica data to the client 7.

Even where more than one terminal node exists, the storage system 1a including the node 3a can obtain replica data transmitted from each terminal node in response to a “Get” request. As a result, the storage system 1a can shorten the time for updating replicas while maintaining strong consistency.

### [c] Third Embodiment

The embodiments that have been described as embodiments of the present invention may be provided in various forms other than the above described forms. In the following, other embodiments of the present invention are described as a third embodiment.

(1) Identification of Paths

In a case where the client 7 has issued a “Put” request to a start node, the above described storage systems 1 and 1a each identify the nodes storing the replicas to be updated, and also identify the paths connecting the identified nodes. However, embodiments are not limited to the above. Specifically, the storage systems 1 and 1a may transmit “update” requests to the respective nodes through paths that are set beforehand for each set of data to be updated.

For example, in a case where the paths for transmitting “update” requests may be fixed, such as a case where the replicas A1 to A4 stored in the respective nodes 2 to 5 are not to be moved to other nodes, the storage systems 1 and 1a each set beforehand the paths for transmitting “update” requests to the nodes 2 to 5. In a case where the node 2 has received a “Put” request, the nodes 2 to 5 may sequentially transfer “update” requests along the predetermined paths.

That is, in a case where “update” requests are transmitted to the respective nodes through more than one path (multipath), the storage systems 1 and 1a can update the replicas in a shorter time than in a case where “update” requests are transmitted to the respective nodes through one path (single path). Therefore, the storage systems 1 and 1a may have fixed paths or may identify paths every time “update” requests are transmitted, as long as the “update” requests can be transmitted through more than one path.

(2) Number of Nodes and Replicas Stored in the Respective Nodes

In the above described examples, the nodes 2 to 6 store the replicas A1 to A4, B1 to B4, and C1 to C4. However, embodiments are not limited to the above, and the number of nodes and the number and types of replicas stored in each of the nodes may be arbitrarily set.

(3) Path Information

In the above described examples, the path information indicating the paths for transmitting “update” requests is stored in the header of each “update” request. However, embodiments are not limited to the above. For example, in a case where the paths for transmitting “update” requests are fixed, there is no need to store the path information. Even if the paths are not fixed, the path information may be sent separately from “update” requests. That is, each node can identify the paths for transmitting “update” requests by using any technique.

(4) Paths

In the above described examples, two or three paths are identified. However, embodiments are not limited to them, and any number of paths can be identified. For example, the topology calculating unit 20 may identify combinations of paths for transmitting “update” requests, and select the combination with which the maximum delay in one way is the shortest among those combinations.

Specifically, where replicas D1 to D5 are stored in the nodes 2 to 6, the delay between each two replicas is 10 msec (milliseconds). In such a case, the topology calculating unit 20 identifies a first combination of the path connecting the node 2, the node 3, the node 4, and the node 6, and the path connecting the node 2, the node 5, and the node 6. The topology calculating unit 20 also identifies a second combination of the path connecting the node 2, the node 3, and the node 6, the path connecting the node 2, the node 4, and the node 6, and the path connecting the node 2, the node 5, and the node 6. In this case, the maximum delay in one way is 10 msec shorter in the second combination, and therefore, the second combination is selected.

(5) Program

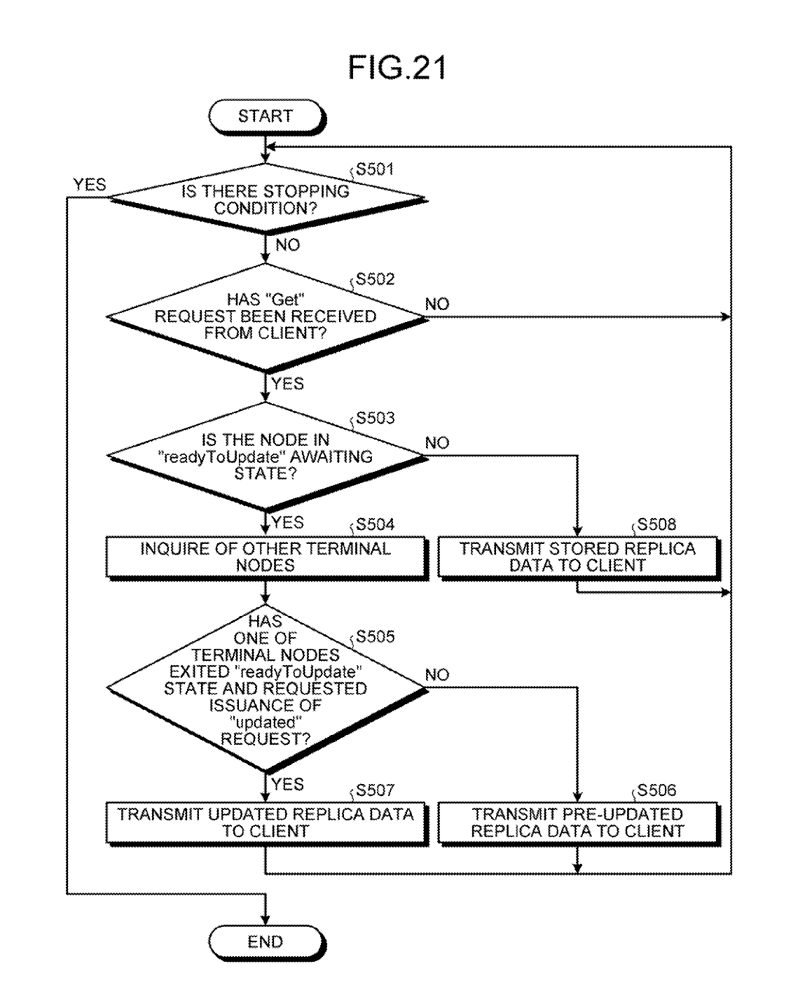

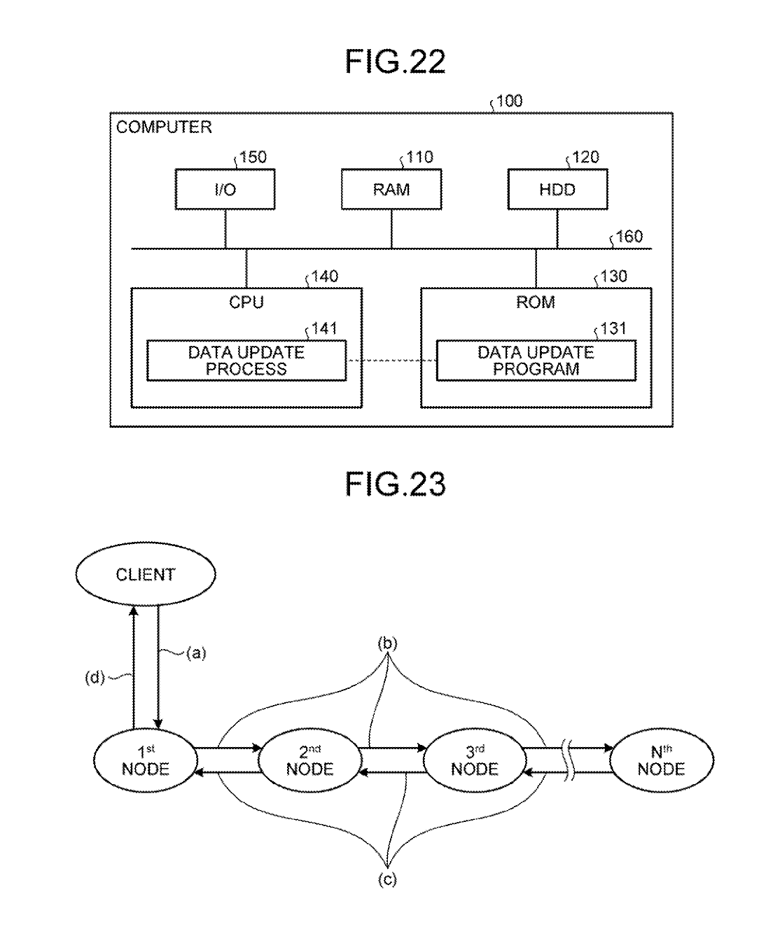

As described above, the nodes 2 to 6 and 2a to 6a according to the first and second embodiments realize various operations by using hardware. However, embodiments are not limited to them, and various operations may be realized by a computer operating as a storage device and executing a predetermined program. Referring now to FIG. 22, an example of a computer that executes a data update program having the same functions as the nodes 2 to 6 of the first embodiment is described. FIG. 22 is a diagram for explaining an example of a computer that executes a data update program.

A computer 100 illustrated in FIG. 22 includes a RAM (Random Access Memory) 110, an HDD (Hard Disk Drive) 120, a ROM (Read Only Memory) 130, and a CPU (Central Processing Unit) 140, which are connected by a bus 160. The computer 100 also has an I/O (Input Output) 150 for communications with other computers. The I/O 150 is also connected to the bus 160.

The HDD 120 stores replicas. The ROM 130 stores a data update program 131. In the example illustrated in FIG. 22, the CPU 140 reads and executes the data update program 131, so that the data update program 131 functions as a data update process 141. The data update process 141 has the same functions as the respective components 11 to 23 illustrated in FIG. 3, but the functions of the request collecting unit 24 illustrated in FIG. 7 and the functions of the other terminal state determining unit 25 illustrated in FIG. 15 can also be added to the data update process 141.

The data update program described in this embodiment can be realized by a computer such as a personal computer or a workstation executing a predetermined program. This program can be distributed via a network such as the Internet. This program is also recorded in a computer-readable recording medium such as a hard disk, a flexible disk (FD), a CD-ROM (Compact Disc Read Only Memory), a MO (Magneto Optical Disc), or a DVD (Digital Versatile Disc). This program can also be read from a recording medium and be executed by a computer.

In one aspect, the time for updating replicas is shortened.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage device being one of a plurality of storage devices storing replicas of data, the storage device comprises:
a memory; and
a processor coupled to the memory, wherein the processor executes a process comprising:
transmitting an update request for updating of the data to at least one destination storage device through a plurality of paths when the storage device is requested to update the data by a client, the each of paths having the storage device requested to update data by the client as a start point and the destination storage device as a terminal point; and
notifying the client that the updating of the data has been completed when having received a response through one of the paths, the response being issued by the destination storage device serving as the terminal point of the path when the destination storage device receives the update request through all the paths having the destination storage device as the terminal point.

2. The storage device according to claim 1, the process further comprising:
storing installation locations of the respective storage devices; and
identifying a plurality of paths that have the storage device as the start point and connect a plurality of storage devices existing at installation locations close to one another, based on the respective storage device installation locations stored at the storing, wherein
the transmitting includes transmitting the update request to the destination storage device serving as the terminal point of each path through the plurality of paths identified at the identifying.

3. The storage device according to claim 1, wherein the transmitting includes transmitting the update request through the plurality of paths having the same destination storage device serving as the terminal point.

4. A storage device being one of a plurality of storage devices storing replicas of data, the storage device comprises:
a memory; and
a processor coupled to the memory, wherein the processor executes a process comprising:
receiving an update request for updating of the data from another storage device through a plurality of paths having the storage device as a terminal point;
determining whether the storage device has received the update request through all the paths having the storage device as the terminal point at the receiving; and
transmitting a response to the update request to a storage device serving as a start point of each path through all the paths having the storage device as the terminal point, when having determined at the determining that the storage device has received the update request through all the paths having the storage device as the terminal point.

5. A storage device being one of a plurality of storage devices storing replicas of data, the storage device comprises:
a memory; and
a processor coupled to the memory, wherein the processor executes a process comprising:
receiving an update request for updating of the data from another storage device through at least one path that has the storage device as a terminal point;
notifying all destination storage devices serving as terminal points of paths other than the paths having the storage device as the terminal point that the update request has been received, when having received the update request through all the paths having the storage device as the terminal point at the receiving;
determining whether the storage device has received the update request through all the paths having the storage device as the terminal point, and has received a response to the update request from all the destination storage devices serving as terminal points of paths other than the paths having the storage device as the terminal point; and
transmitting a response to the update request to a storage device serving as a start point of the paths through the paths having the storage device as the terminal point, when having determined at the determining that the storage device has received the update request through all the paths having the storage device as the terminal point, and having received the response from all the destination storage devices serving as the terminal points of the paths other than the paths having the storage device as the terminal point.

6. The storage device according to claim 5, the process further comprising:
inquiring of all the destination storage devices serving as the terminal points of the paths other than the paths having the storage device as the terminal point about whether the response has been transmitted, when a request for readout of the data to be updated has been obtained, it is notified at the notifying that the update request has been received, and the response is not transmitted at the transmitting; and
outputting an updated version of the data when having obtained a notification to the effect that that the response has been transmitted from one of the destination storage devices as a response to the inquiry at the inquiring, and outputting a pre-updated version of the data when having not obtained a notification to the effect that the response has been transmitted from one of the destination storage devices as a response to the inquiry at the inquiring.

7. A storage system that includes a plurality of storage devices that store replicas of data, a first storage device, and a second storage device, wherein the first storage device comprises:
a first memory; and
a first processor coupled to the first memory, wherein the first processor executes a process comprising:
transmitting an update request for updating of the data to the second storage device through at least a path that has the first storage device as a start point and the second storage device as a terminal point, when updating of the data is requested by a client;
the second storage device comprises:
a second memory; and
a second processor coupled to the second memory, wherein the second processor executes a process comprising:
determining whether the second storage device has received the update request through all paths having the second storage device as a terminal point; and
transmitting a response to the update request to the first storage device through all the paths when having determined at the determining that the second storage device has received the update request through all the paths.

8. A data updating method comprising:
performing, by a first storage device that is requested to update data by a client, an operation to transmit an update request for updating of the data to a second storage device through at least a path that has the first storage device as a start point and the second storage device as a terminal point; and
performing, by the second storage device, an operation to determine whether the second storage device has received the update request through all paths having the second storage device as a terminal point, and to transmit a response to the update request to the first storage device through all the paths when having determined that the second storage device has received the update request through all the paths.

9. A non-transitory computer-readable recording medium having stored therein a data update program for causing a computer, being one of a plurality of computers, to execute a data update process comprising:
transmitting an update request for updating of the data to at least one destination computer through a plurality of paths when the computer is requested to update the data by a client, the each of paths having the computer requested to update data by the client as a start point and the destination computer as a terminal point; and
notifying the client that the updating of the data has been completed when having received a response through one of the paths, the response being issued by the destination computer serving as the terminal point of the path when the destination computer receives the update request through all the paths having the destination computer as the terminal point.

10. A non-transitory computer-readable recording medium having stored therein a data update program for causing a computer, being one of a plurality of computers, to execute a data update process comprising:
receiving an update request for updating of the data from another computer through a plurality of paths having the computer as a terminal point;
determining whether the computer has received the update request through all the paths having the computer as the terminal point at the receiving; and
transmitting a response to the update request to a computer serving as a start point of each path through all the paths having the computer as the terminal point, when having determined at the determining that the computer has received the update request through all the paths having the computer as the terminal point.

11. A non-transitory computer-readable recording medium having stored therein a data update program for causing a computer, being one of a plurality of computers, to execute a data update process comprising
receiving an update request for updating of the data from another computer through at least one path that has the computer as a terminal point;
notifying all destination computers serving as terminal points of paths other than the paths having the computer as the terminal point that the update request has been received, when having received the update request through all the paths having the computer as the terminal point at the receiving;
determining whether the computer has received the update request through all the paths having the computer as the terminal point, and has received a response to the update request from all the destination computers serving as terminal points of paths other than the paths having the computer as the terminal point; and
transmitting a response to the update request to a computer serving as a start point of the paths through the paths having the computer as the terminal point, when having determined at the determining that the computer has received the update request through all the paths having the computer as the terminal point, and having received the response from all the destination computers serving as the terminal points of the paths other than the paths having the computer as the terminal point.
